(19) United States
(12) Patent Application Publication
(10) Pub. No.: US 2024/0094334 A1
(43) Pub. Date: Mar. 21, 2024

(54) ACCURATE ANGLE-OF-ARRIVAL ESTIMATION IN LINEAR ANTENNA ARRAYS

(71) Applicant: QUALCOMM Incorporated, San Diego, CA (US)

(72) Inventors: Peyman SIYARI, San Jose, CA (US); Xiaoxin ZHANG, Sunnyvale, CA (US); Sudhanshu SINGH, Hyderabad (IN); Mukul SHARMA, Hyderabad (IN); Ta-Nien LI, Taipei City (TW); Chinamay KUMAR, Hyderabad (IN)

(21) Appl. No.: 18/446,260

(22) Filed: Aug. 8, 2023

Related U.S. Application Data
(60) Provisional application No. 63/376,198, filed on Sep. 19, 2022.

(51) Int. Cl. G01S 7/10; G01S 3/14; G01S 7/22; G01S 13/74

(52) U.S. Cl. CPC G01S 7/10; G01S 3/14; G01S 7/22; G01S 13/74

(57) ABSTRACT

Disclosed are techniques for wireless positioning. In an aspect, a wireless device receives one or more radio frequency (RF) signals from a transmitter device, displays a first arrow and a second arrow on a user interface of the wireless device, a direction of the first arrow representing a first angle-of-arrival (AoA) estimate of the one or more RF signals, and a direction of the second arrow representing a mirror AoA estimate of the first AoA estimate, and displays one or more notifications on the user interface instructing a user of the wireless device to move the wireless device until the direction of the first arrow is aligned with the direction of the second arrow.

### CROSS-REFERENCE TO RELATED APPLICATIONS

The present Application for Patent claims the benefit of U.S. Provisional Application No. 63/376,198, entitled “ACCURATE ANGLE-OF-ARRIVAL ESTIMATION IN LINEAR ANTENNA ARRAYS,” filed Sep. 19, 2022, assigned to the assignee hereof, and expressly incorporated herein by reference in its entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless positioning performed by a wireless device includes receiving one or more radio frequency (RF) signals from a transmitter device; displaying a first arrow and a second arrow on a user interface of the wireless device, a direction of the first arrow representing a first angle-of-arrival (AoA) estimate of the one or more RF signals, and a direction of the second arrow representing a mirror AoA estimate of the first AoA estimate; and displaying one or more notifications on the user interface instructing a user of the wireless device to move the wireless device until the direction of the first arrow is aligned with the direction of the second arrow.

In an aspect, a method of wireless positioning performed by a wireless device includes receiving one or more radio frequency (RF) signals from a transmitter device; displaying one or more notifications on a user interface of the wireless device instructing a user of the wireless device to move the wireless device; determining an angle-of-arrival (AoA) of the one or more RF signals as corresponding to either a first AoA estimate of the one or more RF signals or a mirror AoA estimate of the first AoA estimate based on sensor data from one or more sensors of the wireless device, the sensor data indicating at least a direction of rotation of the wireless device caused by movement of the wireless device; and displaying an arrow on the user interface, a direction of the arrow representing the AoA of the one or more RF signals.

In an aspect, a method of wireless positioning performed by a wireless device includes displaying a three-dimensional shape on a user interface of the wireless device; displaying a pin on the three-dimensional shape, a position of the pin on the three-dimensional shape indicating an orientation of the wireless device relative to an azimuth plane or an elevation plane; displaying a target icon on the three-dimensional shape, a position of the target icon on the three-dimensional shape indicating a target position of the pin at which the orientation of the wireless device will be aligned with the azimuth plane or the elevation plane; and displaying a notification on the user interface instructing a user of the wireless device to move the wireless device until the pin is positioned on the target icon.

In an aspect, a method of wireless positioning performed by a wireless device includes displaying one or more first notifications on a user interface of the wireless device instructing a user of the wireless device to hold the wireless device parallel to an azimuth plane; determining a first angle-of-arrival (AoA) in the azimuth plane of one or more first radio frequency (RF) signals received from a transmitter device; displaying one or more second notifications on the user interface instructing the user to hold the wireless device parallel to an elevation plane; and determining a second AoA in the elevation plane of one or more second RF signals received from the transmitter device.

In an aspect, a wireless device includes one or more memories; one or more transceivers; and one or more processors communicatively coupled to the one or more memories and the one or more transceivers, the one or more processors, either alone or in combination, configured to: receive, via the one or more transceivers, one or more radio frequency (RF) signals from a transmitter device; display a first arrow and a second arrow on a user interface of the wireless device, a direction of the first arrow representing a first angle-of-arrival (AoA) estimate of the one or more RF signals, and a direction of the second arrow representing a mirror AoA estimate of the first AoA estimate; and display one or more notifications on the user interface instructing a user of the wireless device to move the wireless device until the direction of the first arrow is aligned with the direction of the second arrow.

In an aspect, a wireless device includes one or more memories; one or more transceivers; and one or more processors communicatively coupled to the one or more memories and the one or more transceivers, the one or more processors, either alone or in combination, configured to: receive, via the one or more transceivers, one or more radio frequency (RF) signals from a transmitter device; display one or more notifications on a user interface of the wireless device instructing a user of the wireless device to move the wireless device; determine an angle-of-arrival (AoA) of the one or more RF signals as corresponding to either a first AoA estimate of the one or more RF signals or a mirror AoA estimate of the first AoA estimate based on sensor data from one or more sensors of the wireless device, the sensor data indicating at least a direction of rotation of the wireless device caused by movement of the wireless device; and display an arrow on the user interface, a direction of the arrow representing the AoA of the one or more RF signals.

In an aspect, a wireless device includes one or more memories; one or more transceivers; and one or more processors communicatively coupled to the one or more memories and the one or more transceivers, the one or more processors, either alone or in combination, configured to: display a three-dimensional shape on a user interface of the wireless device; display a pin on the three-dimensional shape, a position of the pin on the three-dimensional shape indicating an orientation of the wireless device relative to an azimuth plane or an elevation plane; display a target icon on the three-dimensional shape, a position of the target icon on the three-dimensional shape indicating a target position of the pin at which the orientation of the wireless device will be aligned with the azimuth plane or the elevation plane; and display a notification on the user interface instructing a user of the wireless device to move the wireless device until the pin is positioned on the target icon.

In an aspect, a wireless device includes one or more memories; one or more transceivers; and one or more processors communicatively coupled to the one or more memories and the one or more transceivers, the one or more processors, either alone or in combination, configured to: display one or more first notifications on a user interface of the wireless device instructing a user of the wireless device to hold the wireless device parallel to an azimuth plane; determine a first angle-of-arrival (AoA) in the azimuth plane of one or more first radio frequency (RF) signals received from a transmitter device; display one or more second notifications on the user interface instructing the user to hold the wireless device parallel to an elevation plane; and determine a second AoA in the elevation plane of one or more second RF signals received from the transmitter device.

In an aspect, a wireless device includes means for receiving one or more radio frequency (RF) signals from a transmitter device; means for displaying a first arrow and a second arrow on a user interface of the wireless device, a direction of the first arrow representing a first angle-of-arrival (AoA) estimate of the one or more RF signals, and a direction of the second arrow representing a mirror AoA estimate of the first AoA estimate; and means for displaying one or more notifications on the user interface instructing a user of the wireless device to move the wireless device until the direction of the first arrow is aligned with the direction of the second arrow.

In an aspect, a wireless device includes means for receiving one or more radio frequency (RF) signals from a transmitter device; means for displaying one or more notifications on a user interface of the wireless device instructing a user of the wireless device to move the wireless device; means for determining an angle-of-arrival (AoA) of the one or more RF signals as corresponding to either a first AoA estimate of the one or more RF signals or a minor AoA estimate of the first AoA estimate based on sensor data from one or more sensors of the wireless device, the sensor data indicating at least a direction of rotation of the wireless device caused by movement of the wireless device; and means for displaying an arrow on the user interface, a direction of the arrow representing the AoA of the one or more RF signals.

In an aspect, a wireless device includes means for displaying a three-dimensional shape on a user interface of the wireless device; means for displaying a pin on the three-dimensional shape, a position of the pin on the three-dimensional shape indicating an orientation of the wireless device relative to an azimuth plane or an elevation plane; means for displaying a target icon on the three-dimensional shape, a position of the target icon on the three-dimensional shape indicating a target position of the pin at which the orientation of the wireless device will be aligned with the azimuth plane or the elevation plane; and means for displaying a notification on the user interface instructing a user of the wireless device to move the wireless device until the pin is positioned on the target icon.

In an aspect, a wireless device includes means for displaying one or more first notifications on a user interface of the wireless device instructing a user of the wireless device to hold the wireless device parallel to an azimuth plane; means for determining a first angle-of-arrival (AoA) in the azimuth plane of one or more first radio frequency (RF) signals received from a transmitter device; means for displaying one or more second notifications on the user interface instructing the user to hold the wireless device parallel to an elevation plane; and means for determining a second AoA in the elevation plane of one or more second RF signals received from the transmitter device.

In an aspect, a non-transitory computer-readable medium stores computer-executable instructions that, when executed by a wireless device, cause the wireless device to: receive one or more radio frequency (RF) signals from a transmitter device; display a first arrow and a second arrow on a user interface of the wireless device, a direction of the first arrow representing a first angle-of-arrival (AoA) estimate of the one or more RF signals, and a direction of the second arrow representing a mirror AoA estimate of the first AoA estimate; and display one or more notifications on the user interface instructing a user of the wireless device to move the wireless device until the direction of the first arrow is aligned with the direction of the second arrow.

In an aspect, a non-transitory computer-readable medium stores computer-executable instructions that, when executed by a wireless device, cause the wireless device to: receive one or more radio frequency (RF) signals from a transmitter device; display one or more notifications on a user interface of the wireless device instructing a user of the wireless device to move the wireless device; determine an angle-of-arrival (AoA) of the one or more RF signals as corresponding to either a first AoA estimate of the one or more RF signals or a mirror AoA estimate of the first AoA estimate based on sensor data from one or more sensors of the wireless device, the sensor data indicating at least a direction of rotation of the wireless device caused by movement of the wireless device; and display an arrow on the user interface, a direction of the arrow representing the AoA of the one or more RF signals.

In an aspect, a non-transitory computer-readable medium stores computer-executable instructions that, when executed by a wireless device, cause the wireless device to: display a three-dimensional shape on a user interface of the wireless device; display a pin on the three-dimensional shape, a position of the pin on the three-dimensional shape indicating an orientation of the wireless device relative to an azimuth plane or an elevation plane; display a target icon on the three-dimensional shape, a position of the target icon on the three-dimensional shape indicating a target position of the pin at which the orientation of the wireless device will be aligned with the azimuth plane or the elevation plane; and display a notification on the user interface instructing a user of the wireless device to move the wireless device until the pin is positioned on the target icon.

In an aspect, a non-transitory computer-readable medium stores computer-executable instructions that, when executed by a wireless device, cause the wireless device to: display one or more first notifications on a user interface of the wireless device instructing a user of the wireless device to hold the wireless device parallel to an azimuth plane; determine a first angle-of-arrival (AoA) in the azimuth plane of one or more first radio frequency (RF) signals received from a transmitter device; display one or more second notifications on the user interface instructing the user to hold the wireless device parallel to an elevation plane; and determine a second AoA in the elevation plane of one or more second RF signals received from the transmitter device.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIG. 3 is a simplified block diagrams of several sample aspects of components that may be employed in a user equipment (UE) and configured to support communications as taught herein.

FIG. 4 is a graph representing an example radio frequency (RF) channel estimate, according to aspects of the disclosure.

FIG. 5 is a diagram illustrating aspects of angle-of-arrival (AoA) estimation using a linear antenna, according to aspects of the disclosure.

FIG. 6 is a diagram illustrating a technique for resolving AoA ambiguity without sensor data, according to aspects of the disclosure.

FIG. 7 is a diagram illustrating a technique for resolving AoA ambiguity with sensor data, according to aspects of the disclosure.

FIG. 8 is a diagram illustrating a technique for resolving AoA ambiguity in the azimuth plane, according to aspects of the disclosure.

FIG. 9 is a diagram illustrating a technique for resolving AoA ambiguity in the elevation plane, according to aspects of the disclosure.

FIGS. 10 to 13 illustrate example methods of wireless positioning, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to angle-of-arrival (AoA) estimation. Some aspects more specifically relate to addressing AoA ambiguity. In some examples, to determine an azimuth angle, a user device is configured to be in the horizontal plane and rotated to remove an azimuth angle ambiguity. To determine an elevation angle, the user device is configured to be in the vertical plane and rotated to remove an elevation angle ambiguity.

Particular aspects of the subject matter described in this disclosure can be implemented to realize one or more of the following potential advantages. In some examples, by rotating the user device, the described techniques can be used to remove AoA ambiguity.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer-executable instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

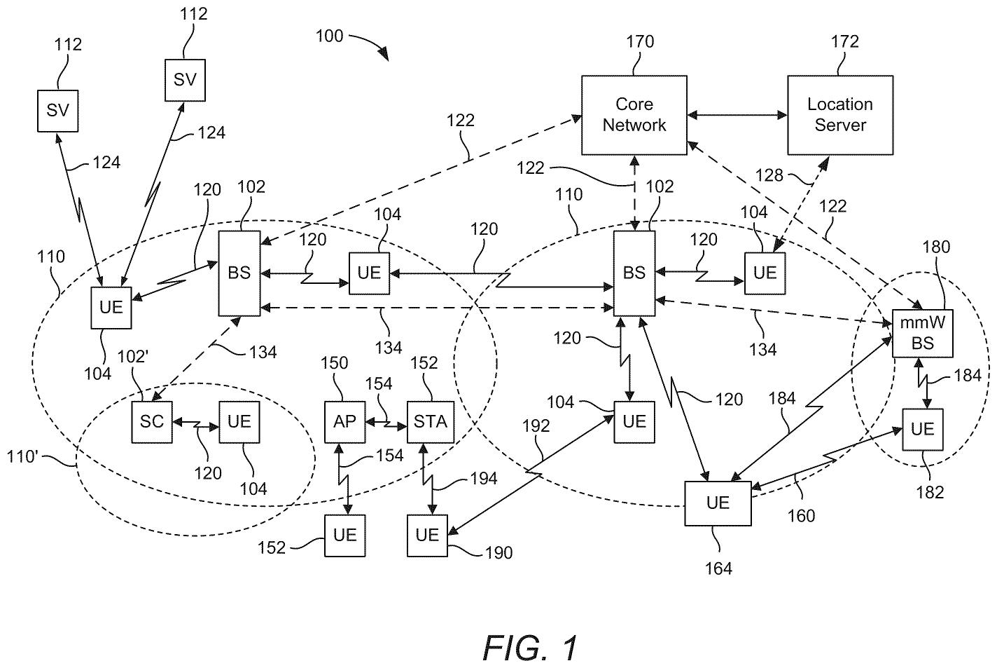

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-

terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

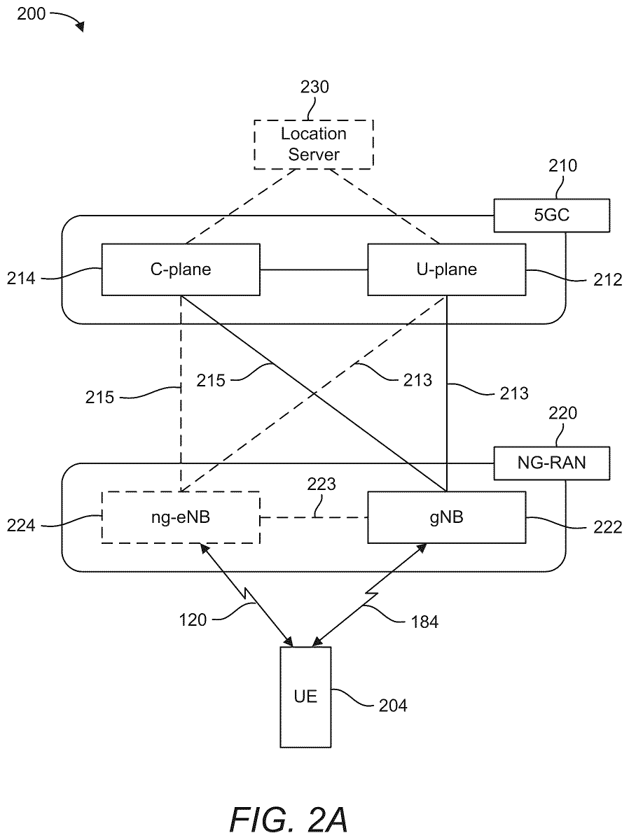

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/ downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB -CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB -CU 226 generally host the radio resource control (RRC), service data adaptation protocol (SDAP), and packet data convergence protocol (PDCP) protocols of the gNB 222. A gNB -DU 228 is a logical node that generally hosts the radio link control (RLC) and medium access control (MAC) layer of the gNB 222. Its operation is controlled by the gNB -CU 226. One gNB -DU 228 can support one or more cells, and one cell is supported by only one gNB -DU 228. The interface 232 between the gNB -CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB -DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

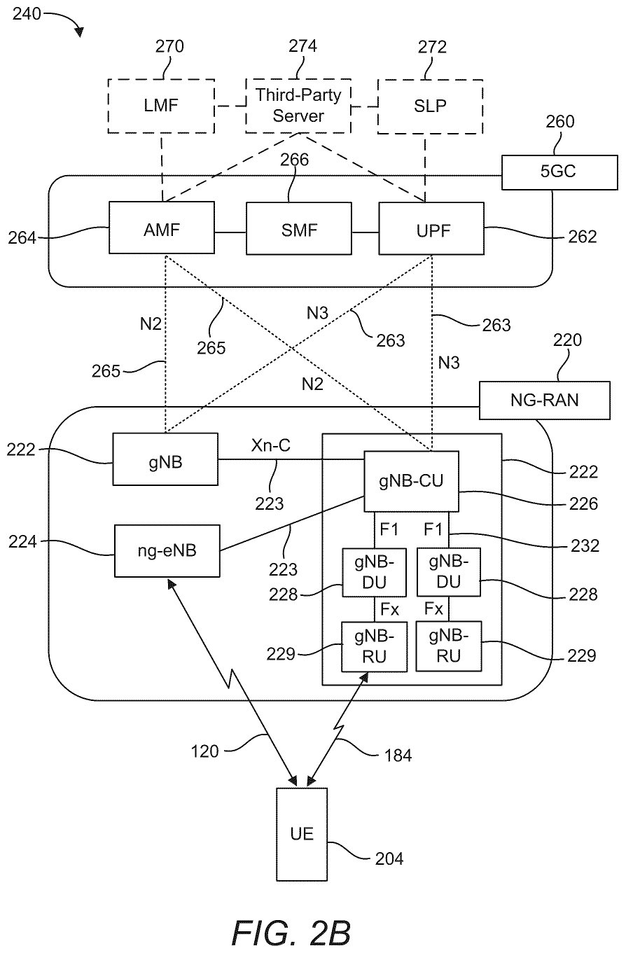

FIG. 3 illustrates several example components (represented by corresponding blocks) that may be incorporated into a UE 302 (which may correspond to any of the UEs described herein). It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 includes one or more wireless wide area network (WWAN) transceivers 310 providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The one or more WWAN transceivers 310 may each be connected to one or more antennas 316 for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The one or more WWAN transceivers 310 may be variously configured for transmitting and encoding signals 318 (e.g., messages, indications, information, and so on) and, conversely, for receiving and decoding signals 318 (e.g., messages, indications, information, pilots, and so on) in accordance with the designated RAT. Specifically, the one or more WWAN transceivers 310 include one or more transmitters 314 for transmitting and encoding signals 318 and one or more receivers 312 for receiving and decoding signals 318.

The UE 302 also includes, at least in some cases, one or more short-range wireless transceivers 320. The one or more short-range wireless transceivers 320 may be connected to one or more antennas 326 and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE-D, Bluetooth®, Zigbee®, Z-Wave®, PCS, dedicated short-range communications (DSRC), wireless access for vehicular environments (WAVE), near-field communication (NFC), ultra-wideband (UWB), etc.) over a wireless communication medium of interest. The one or more short-range wireless transceivers 320 may be variously configured for transmitting and encoding signals 328 (e.g., messages, indications, information, and so on) and, conversely, for receiving and decoding signals 328 (e.g., messages, indications, information, pilots, and so on) in accordance with the designated RAT. Specifically, the one or more short-range wireless transceivers 320 include one or more transmitters 324 for transmitting and encoding signals 328 and one or more receivers 322 for receiving and decoding signals 328. As specific examples, the one or more short-range wireless transceivers 320 may be Wi-Fi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 302 also includes, at least in some cases, a satellite signal receiver 330. The satellite signal receiver 330 may be connected to one or more antennas 336 and may provide means for receiving and/or measuring satellite positioning/communication signals 338. Where the satellite signal receiver 330 is a satellite positioning system receiver, the satellite positioning/communication signals 338 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receiver 330 is a non-terrestrial network (NTN) receiver, the satellite positioning/communication signals 338 may be communication signals (e.g., carrying control and/or user data) originating from a 5G network. The satellite signal receiver 330 may comprise any suitable hardware and/or software for receiving and processing satellite positioning/communication signals 338. The satellite signal receiver 330 may request information and operations as appropriate from the other systems, and, at least in some cases, perform calculations to determine locations of the UE 302 using measurements obtained by any suitable satellite positioning system algorithm.

A transceiver may be configured to communicate over a wired or wireless link. A transceiver (whether a wired transceiver or a wireless transceiver) includes transmitter circuitry (e.g., transmitters 314, 324) and receiver circuitry (e.g., receivers 312, 322). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver may be coupled to one or more wired network interface ports. Wireless transmitter circuitry (e.g., transmitters 314, 324) may include or be coupled to a plurality of antennas (e.g., antennas 316, 326), such as an antenna array, that permits the respective apparatus (e.g., UE 302) to perform transmit “beamforming,” as described herein. Similarly, wireless receiver circuitry (e.g., receivers 312, 322) may include or be coupled to a plurality of antennas (e.g., antennas 316, 326), such as an antenna array, that permits the respective apparatus (e.g., UE 302) to perform receive beamforming, as described herein. In an aspect, the transmitter circuitry and receiver circuitry may share the same plurality of antennas (e.g., antennas 316, 326), such that the respective apparatus can only receive or transmit at a given time, not both at the same time. A wireless transceiver (e.g., the one or more WWAN transceivers 310, the one or more short-range wireless transceivers 320) may also include a network listen module (NLM) or the like for performing various measurements.

As used herein, the various wireless transceivers (e.g., transceivers 310, 320) and wired transceivers may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station will generally relate to signaling via a wireless transceiver.

The UE 302 also includes other components that may be used in conjunction with the operations as disclosed herein. The UE 302 includes one or more processors 332 for providing functionality relating to, for example, wireless communication, and for providing other processing functionality. The one or more processors 332 may therefore provide means for processing, such as means for determining, means for calculating, means for receiving, means for transmitting, means for indicating, etc. In an aspect, the one or more processors 332 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302 306 includes memory circuitry implementing memory 340 (e.g., each including a memory device) for maintaining information (e.g., information indicative of reserved resources, thresholds, parameters, and so on). The memory 340 may therefore provide means for storing, means for retrieving, means for maintaining, etc. In some cases, the UE 302 may include an angle-of-arrival (AoA) estimator 342. The AoA estimator 342 may be hardware circuits that are part of or coupled to the one or more processors 332 that, when executed, cause the UE 302 to perform the functionality described herein. In other aspects, the AoA estimator 342 may be external to the processors 332 (e.g., part of a modem processing system, integrated with another processing system, etc.). Alternatively, the AoA estimator 342 may be a memory module stored in the memory 340 that, when executed by the one or more processors 332 (or a modem processing system, another processing system, etc.), cause the UE 302 to perform the functionality described herein. FIG. 3 illustrates possible locations of the AoA estimator 342, which may be, for example, part of the one or more WWAN transceivers 310, the memory 340, the one or more processors 332, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include one or more cameras, one or more accelerometers (e.g., micro-electrical mechanical systems (MEMS) devices), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

The various components of the UE 302 may be communicatively coupled to each other over a data bus 334. In an aspect, the data bus 334 may form, or be part of, a communication interface of the UE 302.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on).

For convenience, the UE 302 is shown in FIG. 3 as including various components that may be configured according to the various examples described herein. It will be appreciated, however, that the illustrated components may have different functionality in different designs. In particular, various components in FIG. 3 are optional in alternative configurations and the various aspects include configurations that may vary due to design choice, costs, use of the device, or other considerations. For example, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. For brevity, illustration of the various alternative configurations is not provided herein, but would be readily understandable to one skilled in the art.

The components of FIG. 3 may be implemented in various ways. In some implementations, the components of FIG. 3 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). For simplicity, various operations, acts, and/or functions are described herein as being performed “by a UE.” However, as will be appreciated, such operations, acts, and/or functions may actually be performed by specific components or combinations of components of the UE 302, such as the one or more processors 332, the one or more transceivers 310 and 320, the memory 340, the AoA estimator 342, etc.

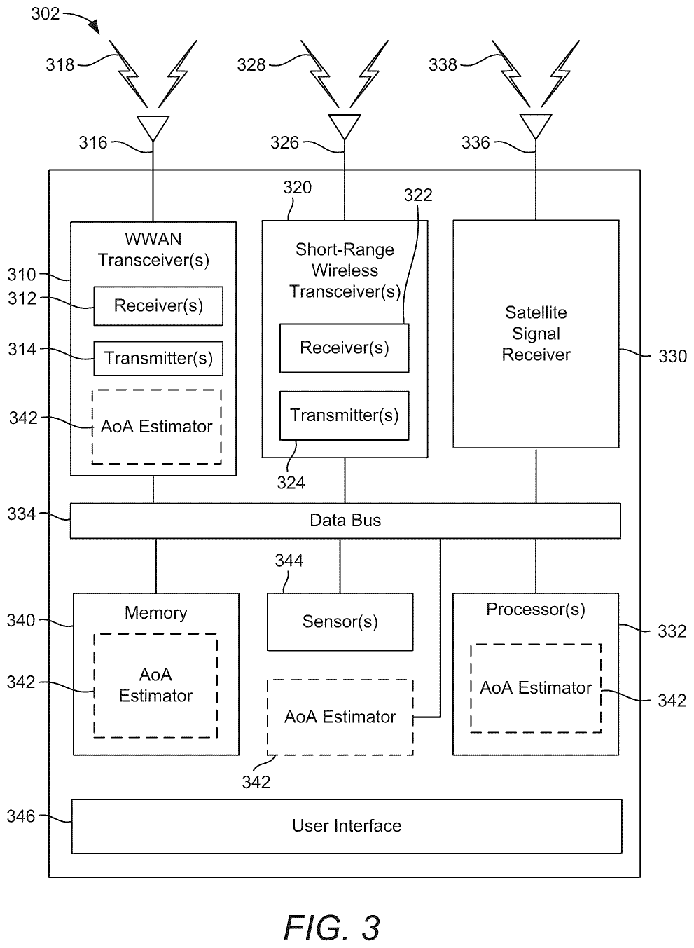

FIG. 4 is a graph 400 representing an example channel estimate of a multipath channel between a receiver device (e.g., any of the UEs or base stations described herein) and a transmitter device (e.g., any other of the UEs or base stations described herein), according to aspects of the disclosure. The channel estimate represents the intensity of a radio frequency (RF) signal (e.g., a PRS) received through a multipath channel as a function of time delay, and may be referred to as the channel energy response, channel impulse response, or power delay profile of the channel. Thus, the horizontal axis is in units of time (e.g., milliseconds) and the vertical axis is in units of signal strength (e.g., decibels). Note that a multipath channel is a channel between a transmitter and a receiver over which an RF signal follows multiple paths, or multipaths, due to transmission of the RF signal on multiple beams and/or to the propagation characteristics of the RF signal (e.g., reflection, refraction, etc.).

In the example of FIG. 4, the receiver detects/measures multiple (four) clusters of channel taps. Each channel tap represents a multipath that an RF signal followed between the transmitter and the receiver. That is, a channel tap represents the arrival of an RF signal on a multipath. Each cluster of channel taps indicates that the corresponding multipaths followed essentially the same path. There may be different clusters due to the RF signal being transmitted on different transmit beams (and therefore at different angles), or because of the propagation characteristics of RF signals (e.g., potentially following different paths due to reflections), or both.

All of the clusters of channel taps for a given RF signal represent the multipath channel (or simply channel) between the transmitter and receiver. Under the channel illustrated in FIG. 4, the receiver receives a first cluster of two RF signals on channel taps at time T1, a second cluster of five RF signals on channel taps at time T2, a third cluster of five RF signals on channel taps at time T3, and a fourth cluster of four RF signals on channel taps at time T4. In the example of FIG. 4, because the first cluster of RF signals at time T1 arrives first, it is assumed to correspond to the RF signal transmitted on the transmit beam aligned with the line-of-sight (LOS), or the shortest, path. The third cluster at time T3 is comprised of the strongest RF signals, and may correspond to, for example, the RF signal transmitted on a transmit beam aligned with a non-line-of-sight (NLOS) path. Note that although FIG. 4 illustrates clusters of two to five channel taps, as will be appreciated, the clusters may have more or fewer than the illustrated number of channel taps.

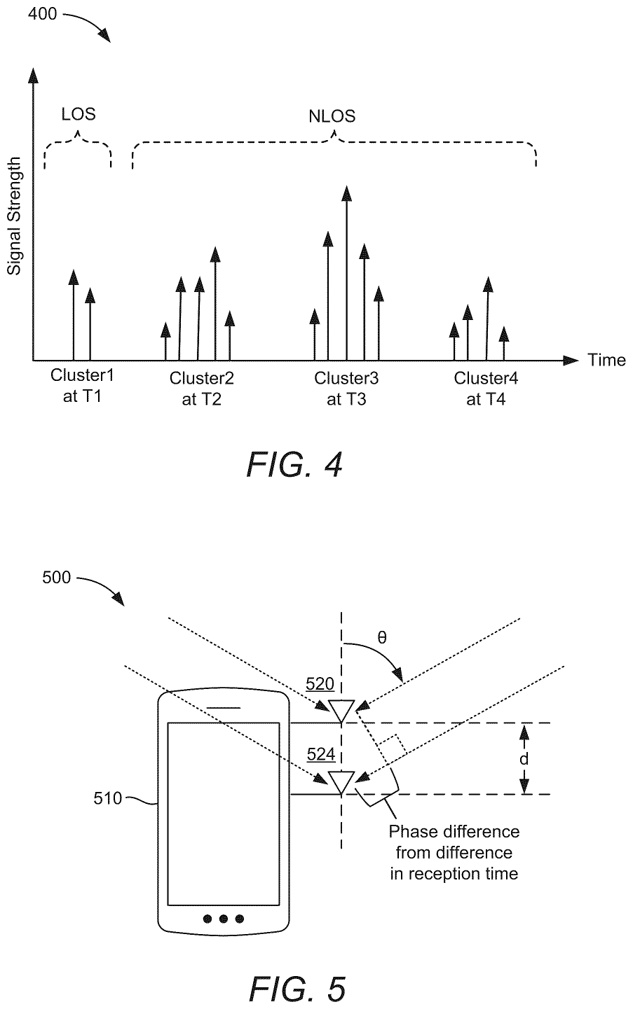

Wireless communications devices (e.g., Wi-Fi, UWB, Bluetooth, 5G NR) with multiple antennas allow angular techniques to be deployed to enable higher accuracy positioning, which in turn enables many advanced location-based use cases, such as asset tracking, targeted advertising, consumer behavior analytics, and more. The number of antennas and the placement of the antennas determines the difficulty of AoA estimation. For example, many wireless devices have their multiple antennas arranged as a linear antenna array. For devices that have only two antennas, for example, such as many smartphones, tablet computers, laptop computers, IoT devices, wearable devices, retail APs, and the like, the antennas are necessarily arranged in a linear array. For devices that have more than two antennas, such as enterprise-level APs, these devices often have their antennas arranged in a linear array for optimized throughput. As described below with reference to FIG. 5, a linear antenna array causes ambiguity in the AoA estimation. Another issue with AoA estimation is that many wireless devices place antennas on the same plane. Such antenna placement limits AoA estimation to the azimuth only with no elevation estimation.

FIG. 5 is a diagram 500 illustrating aspects of AoA estimation using a linear antenna, according to aspects of the disclosure. An AoA estimate is based on the phase difference of an RF signal as received by two or more antennas at different reception times. As shown in FIG. 5, a wireless device 510 has a linear antenna array composed of two antennas separated from each other by a distance “d.” The wireless device 510 may be an example of the UE 302 in FIG. 3, and the antenna array may correspond to the one or more antennas 316 or the one or more antennas 326.

In the example of FIG. 5, the (top) antenna 520 receives an RF signal shortly before the (bottom) antenna 524 receives the RF signal. For example, with reference to FIG. 4, both antennas may receive/measure the same clusters of channel taps, but the reception times of the channel taps at the antenna 524 in FIG. 5 would be slightly after the reception times of the channel taps at the antenna 520.

Because the reception times of the RF signal at the two antennas are not the same, there is a difference in the phase of the RF signal as received at the two antennas. That is, the phase of the RF signal when received at the antenna 524 will be different than the phase of the RF signal when received at the antenna 520. This difference in phase can be used to estimate the AoA of the RF signal, denoted “θ.” However, the wireless device 510 cannot determine whether the RF signal arrived from the “right” or the “left” of the antenna array axis (as indicated by the two sets of arrows in FIG. 5) because there is the same inter-antenna phase difference for both the true angle and the mirrored angle. As such, the wireless device 510 computes two AoA estimates for every channel capture (e.g., channel estimate illustrated in FIG. 4). Thus, as shown, AoA estimation is fundamentally ambiguous with linear antenna arrays. Linear antenna arrays are also not suitable for simultaneous azimuth and elevation computation.

No solution currently exists to resolve AoA ambiguity in two-antenna systems. Accordingly, the present disclosure provides techniques to accurately estimate AoA when using a linear antenna array and/or antennas on the same plane without changing the antenna arrangement. More specifically, the AoA estimation algorithm continues to compute two candidate angles for every channel capture, but the techniques of the present disclosure resolve the resulting AoA ambiguity at the application level. Specifically, a user-friendly application can guide the user to the correct angle. This is a suitable strategy for many practical scenarios, such as when a user wants to find a small personal item, such as a set of keys.

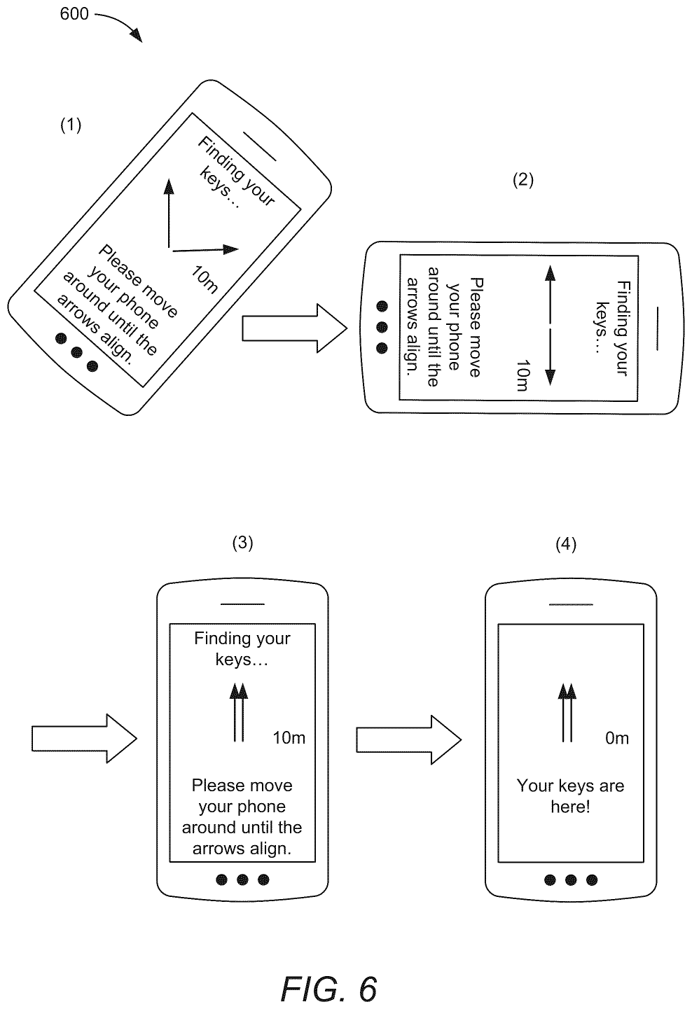

FIG. 6 is a diagram 600 illustrating a technique for resolving AoA ambiguity without

sensor data, according to aspects of the disclosure. In the example of FIG. 6, an application executing on a mobile wireless device is being used to find a user's keys. The user's keys may be attached to a “smart” keychain that can transmit RF signals to the wireless device (using, e.g., Wi-Fi, Bluetooth, 5G NR, UWB, or the like). The wireless device may have a linear antenna array of at least two antennas, like the wireless device 510 in FIG. 5. Based on the received RF signals, the wireless device can estimate the two candidate AoAs of the RF signals, as discussed above with reference to FIG. 5. As noted above, the linear antenna placement limits the AoA estimation to the azimuth angle.

In a first stage, the application displays the two candidate AoAs associated with the RF signal(s) received from the keychain as two arrows pointing in the possible directions of the keychain. The application, via the user interface of the wireless device, can instruct the user to rotate, or move, the wireless device until the two arrows are aligned (or merged into one). For example, the user interface of the wireless device may display a message or notification such as “Please move your phone around until the arrows align.”

In a second stage, the user has rotated or otherwise moved the wireless device and the application updates the user interface to display the two candidate directions for the updated AoA estimate. That is, the application updates the directions of the two arrows to point in the two candidate directions of the updated AoA estimate. In the example of FIG. 6, the correct direction is indicated by the arrow pointing to the left of the wireless device. However, the user has rotated the wireless device in the wrong direction (i.e., away from the vertical arrow and towards the horizontal arrow). As such, the two arrows are shown pointing away from each other.

In a third stage, the user again rotates or otherwise moves the wireless device and the application updates the user interface to display the two candidate directions for the updated AoA estimate. This time, the user has rotated (or moved) the wireless device towards the leftward arrow, which results in updating the directions of the two arrows so that they are aligned. Now, the wireless device is pointing in the direction of the keychain.

In each of the foregoing stages, the user interface displays an estimated distance, or range, between the wireless device and the keychain. This distance can be determined based on ranging operations between the wireless device and the keychain using, for example, Wi-Fi, Bluetooth, 5G NR, UWB, or the like, as is known in the art. As shown in FIG. 6, in the first three stages, the distance between the wireless device and the keychain is 10 meters (m). However, in the fourth stage, once the user has moved with the wireless device in the indicated direction and the distance between the wireless device and the keychain reaches 0 m, the user interface can display an indication that the keychain should be at that location. For example, the user interface can display a message or notification such as “Your keys are here!”

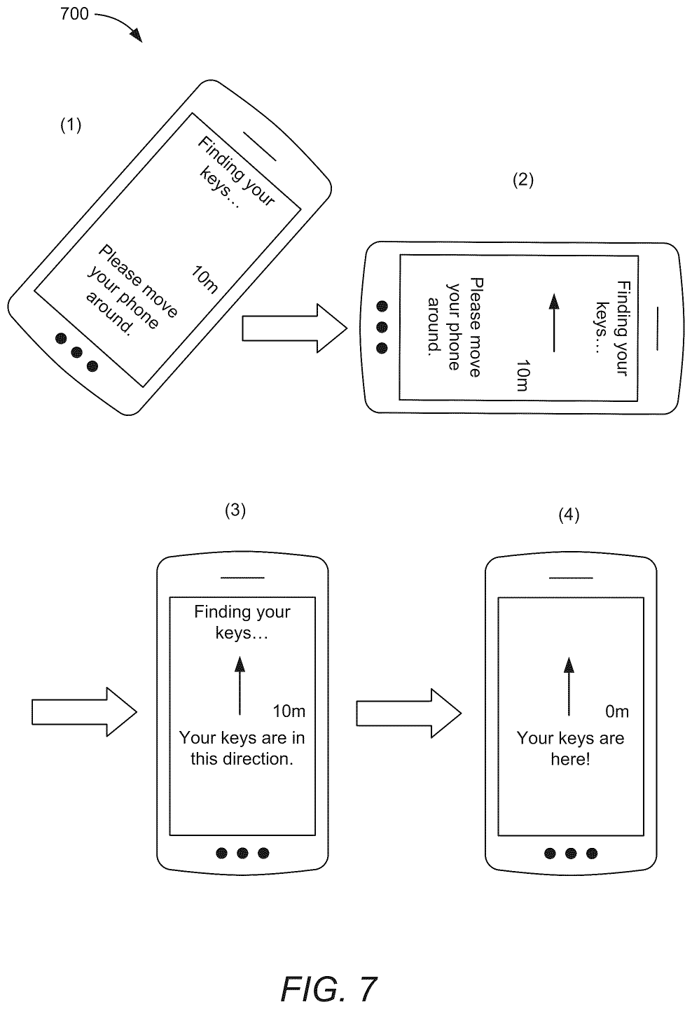

FIG. 7 is a diagram 700 illustrating a technique for resolving AoA ambiguity with sensor data, according to aspects of the disclosure. In the example of FIG. 7, as in the example of FIG. 6, an application executing on a mobile wireless device is being used to find a user's keys. The user's keys may be attached to a “smart” keychain that can transmit RF signals to the wireless device (using, e.g., Wi-Fi, Bluetooth, 5G NR, UWB, or the like). The wireless device may have a linear antenna array of at least two antennas, like the wireless device 510 in FIG. 5. Based on the received RF signals, the wireless device can estimate the two candidate AoAs of the RF signals, as discussed above with reference to FIG. 5. As noted above, the linear antenna placement limits the AoA estimation to the azimuth angle.

With this technique, the application uses sensor data to remove the ambiguity of the two AoA candidates. The sensor data may come from one or more cameras (e.g., one or more front and/or back-facing cameras), an on-board compass (which can indicate how much the wireless device has rotated (i.e., an amount of rotation of the wireless device)), an accelerometer (which can indicate whether the wireless device has rotated), or the like.

In a first stage, the application has calculated the two AoA candidates. However, because the user has not yet moved the wireless device, the application refrains from displaying an arrow on the user interface. The user interface instead displays a message (notification) instructing the user to rotate, or move, the wireless device. For example, the user interface of the wireless device may display a message (notification) such as “Please move your phone around.” Note that instead of refraining from displaying an arrow, the user interface may instead display two arrows, as in the first stage of FIG. 6.

In a second stage, based on the user moving the wireless device, the application gathers sensor data to compare the wireless device's previous candidate angles (from the first stage) with the newly estimated candidate angles (at the second stage). Using the sensor data (indicating the direction of rotation of the wireless device), the application can resolve the ambiguity of the two candidate AoA estimates. For example, assuming the same angle estimates as shown in FIG. 6, if the user rotates the wireless device to the right, the new angle estimates point in opposite directions (as shown in the second stage of FIG. 6). Knowing from the sensor data, however, that the wireless device was rotated to the right, resulting in the greater divergence of the angle estimates, the application can determine that the left-pointing angle estimate is the correct AoA estimate. The user interface therefore displays a single arrow pointing in that direction, as shown in FIG. 7.

In a third stage, the user rotates or otherwise moves the wireless device to point in the direction of the arrow. In each of the first three stages, the user interface displays an estimated distance, or range, between the wireless device and the keychain. As noted above, this distance can be determined based on ranging operations between the wireless device and the keychain using, for example, Wi-Fi, Bluetooth, 5G NR, UWB, or the like, as is known in the art. As shown in FIG. 7, in the first three stages, the distance between the wireless device and the keychain is 10 m. However, in the fourth stage, once the user has moved with the wireless device in the indicated direction and the distance between the wireless device and the keychain reaches 0 m, the user interface can display an indication that the keychain should be at that location. For example, the user interface can display a message (notification) such as “Your keys are here!”

Note that while FIGS. 6 and 7 illustrate the range between the wireless device and the keychain at each stage, this is not necessary. Instead, the range may be displayed only once the arrows are aligned (FIG. 6), once the first arrow is displayed (FIG. 7), once the wireless device is pointing towards the keychain, or even not at all, depending on how the techniques of the present disclosure are being implemented.

In both FIGS. 6 and 7, the application may recalculate the AoA estimate and update the user interface to display the updated arrow(s) every time an RF signal is received from the keychain. Depending on the frequency with which the RF signals are received, this may permit the user interface to update continuously (i.e., so frequently that it appears continuous to the user), every time motion is detected (e.g., by one or more on-board accelerometers), periodically, or the like.

In an aspect, the application may be running locally on the wireless device or remotely, such as on a network server.

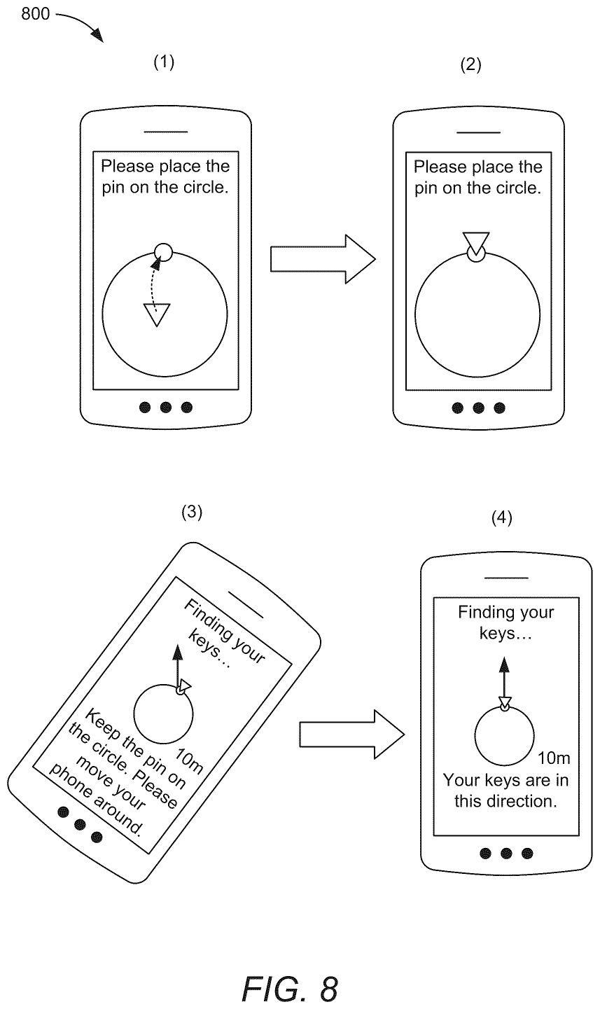

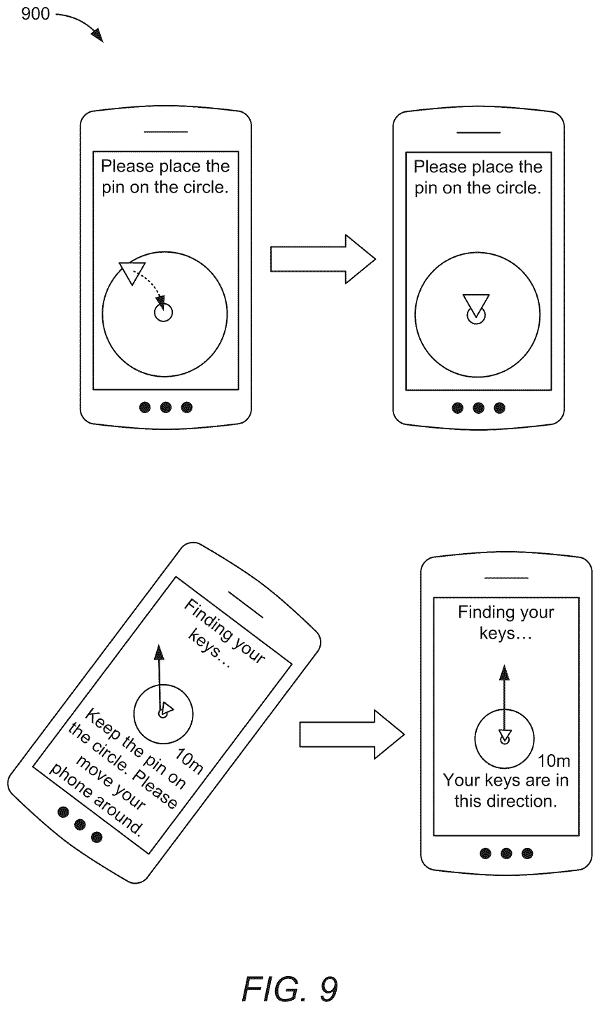

A third technique described herein enables simultaneous azimuth and elevation computation with sensor data. In this technique, the application displays a three-dimensional (3D) sphere (or half sphere or other such 3D shape) with a pin that moves according to the wireless device's gyroscope and/or accelerometer(s). Rotation of the wireless device in the azimuth or elevation planes moves the pin on the sphere. An icon representing a target position for the pin is displayed on the sphere, and the application instructs the user to move the point to the icon (i.e., target position). When the pin is placed at the target position, the wireless device is oriented in either the azimuth or elevation plane. For example, as shown in FIG. 8, when the pin is at the target position at the top of the sphere, the wireless device is oriented in the azimuth plane. As shown in FIG. 9, when the pin is at the target position in the center/middle of the sphere, the wireless device is oriented in the elevation plane. Once the pin is at the target position, the application can run either the first technique (without sensor data) or the second technique (with sensor data) for angle estimation.

FIG. 8 is a diagram 800 illustrating a technique for resolving AoA ambiguity in the azimuth plane, according to aspects of the disclosure. In the example of FIG. 8, as in the examples of FIGS. 6 and 7, an application executing on a mobile wireless device is being used to find a user's keys. The user's keys may be attached to a “smart” keychain that can transmit RF signals to the wireless device (using, e.g., Wi-Fi, Bluetooth, 5G NR, UWB, or the like). The wireless device may have a linear antenna array of at least two antennas, like the wireless device 510 in FIG. 5.

In the first stage, the user interface of the wireless device displays a sphere, a pin (illustrated as a triangle) indicating the current orientation of the wireless device in the azimuth plane, and a target position for the pin (identified by an icon shaped as a circle). The user is instructed to move the pin to the icon (target position) by a message (notification) such as “Please place the pin on the circle.” In the second stage, the user has moved the pin as directed. Note that the target position (the circle) has not moved.

The application now performs the first or second technique described above with reference to FIGS. 6 and 7, respectively. In the example of FIG. 8, the application performs the second technique (FIG. 7). As such, the third and fourth stages of FIG. 8 correspond to the second and third stages of FIG. 7. For simplicity, the other stages are not illustrated.

FIG. 9 is a diagram 900 illustrating a technique for resolving AoA ambiguity in the elevation plane, according to aspects of the disclosure. In the example of FIG. 9, as in the examples of FIGS. 6-8, an application executing on a mobile wireless device is being used to find a user's keys. The user's keys may be attached to a “smart” keychain that can transmit RF signals to the wireless device (using, e.g., Wi-Fi, Bluetooth, 5G NR, UWB, or the like). The wireless device may have a linear antenna array of at least two antennas, like the wireless device 510 in FIG. 5.

In the first stage, the user interface of the wireless device displays a sphere, a pin (illustrated as a triangle) indicating the current orientation of the wireless device in the elevation plane, and a target position for the pin (illustrated as a circle). The user is instructed to move the pin to the target position by a message (notification) such as “Please place the pin on the circle.” In the second stage, the user has moved the pin as directed. Note that the target position (the circle) has not moved.

The application now performs the first or second technique described above with reference to FIGS. 6 and 7, respectively. Note that while in the examples of FIGS. 6 and 7 the azimuth angle was being calculated, as will be appreciated, the same procedure can be used to estimate the elevation angle. In the example of FIG. 9, the application performs the second technique (FIG. 7). As such, the third and fourth stages of FIG. 9 correspond to the second and third stages of FIG. 7. For simplicity, the other stages are not illustrated.

With respect to FIGS. 8 and 9, the application may first perform the azimuth alignment to determine the azimuth angle and then the elevation alignment to determine the elevation angle. Or the application may first perform the elevation alignment and then the azimuth alignment. Once the azimuth and elevation angles have been determined, the application can display a combined direction arrow or separate arrows for azimuth and elevation.

Note that while FIGS. 6 to 9 illustrate the mobile wireless device as a smartphone, it will be appreciated that it may be any type of mobile wireless device with a user interface, such as a tablet computer, “smart” watch, etc. Similarly, while the examples of FIGS. 6 and 7 describe the transmitting entity as a smart keychain, the keychain may be any type of transmitter device from which the wireless device can receive RF signals (e.g., other “smart” devices, IoT devices, beacon transmitters, base stations, etc.).

A fourth technique described herein enables both azimuth and elevation computation without sensor data. In this technique, for the azimuth calculation, the application displays a message (notification) instructing the user to hold the wireless device parallel to the floor (e.g., where the wireless device is a smartphone, the back of the phone should face the floor). Once the wireless device is properly oriented, the user initializes the azimuth computation (FIG. 6, as there is no sensor data available in this technique) within the application. For example, there may be a button on the user interface of the wireless device for the user to tap when the wireless device is positioned correctly.

During the azimuth computation, the application reminds (e.g., displays a reminder) the user to keep the wireless device parallel to the floor. Once the azimuth angle has been calculated (using the techniques described above with reference to FIG. 6), the application switches to the elevation computation. For the elevation calculation, the application instructs the user to keep the wireless device perpendicular to the floor (e.g., where the wireless device is a smartphone, the bottom of the phone should face the floor). Once the wireless device is properly oriented, the user initializes the elevation computation (FIG. 6, as there is no sensor data available in this technique) within the application.

During the elevation computation, the application reminds (e.g., displays a reminder) the user to keep the phone perpendicular to the floor. Once the elevation angle has been calculated (using the techniques described above with reference to FIG. 6), the application can display a combined direction arrow or separate arrows for azimuth and elevation.

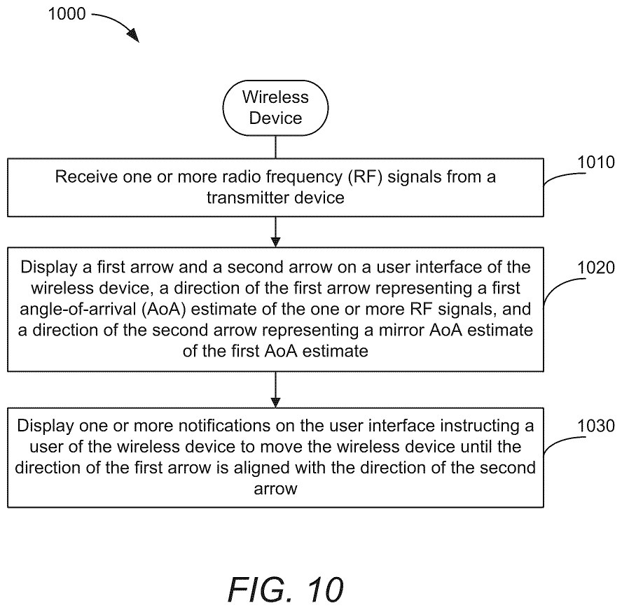

FIG. 10 illustrates an example method 1000 of wireless positioning, according to aspects of the disclosure. In an aspect, method 1000 may be performed by a wireless device (e.g., any of the wireless devices described herein).

At 1010, the wireless device receives one or more RF signals from a transmitter device (e.g., a “smart” keychain), as at the first stage of FIG. 6. In an aspect, operation 1010 may be performed by the one or more WWAN transceivers 310, the one or more processors 332, memory 340, and/or AoA estimator 342, any or all of which may be considered means for performing this operation.

At 1020, the wireless device displays a first arrow and a second arrow on a user interface of the wireless device, a direction of the first arrow representing a first AoA estimate of the one or more RF signals, and a direction of the second arrow representing a mirror AoA estimate of the first AoA estimate, as at the first through fourth stages of FIG. 6. In an aspect, operation 1020 may be performed by the one or more WWAN transceivers 310, the one or more processors 332, memory 340, and/or AoA estimator 342, any or all of which may be considered means for performing this operation.

At 1030, the wireless device displays one or more notifications on the user interface instructing a user of the wireless device to move the wireless device until the direction of the first arrow is aligned with the direction of the second arrow, as at the first, second, and third stages of FIG. 6. In an aspect, operation 1030 may be performed by the one or more WWAN transceivers 310, the one or more processors 332, memory 340, and/or AoA estimator 342, any or all of which may be considered means for performing this operation.

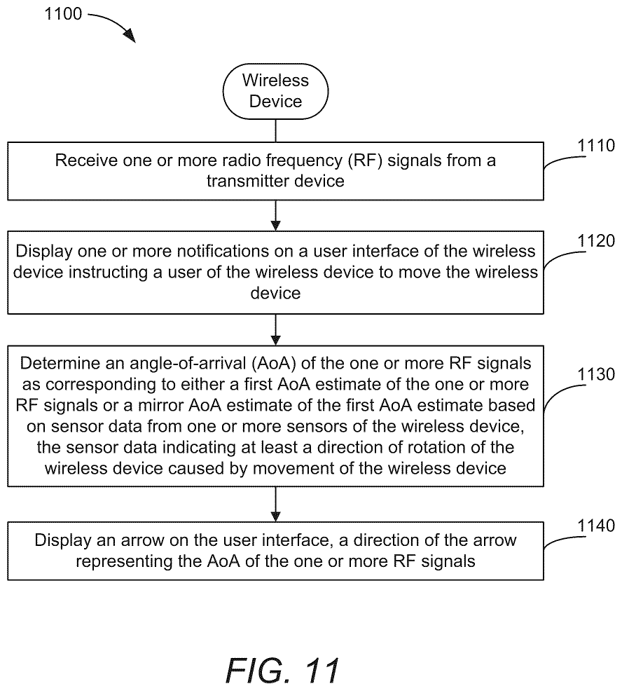

FIG. 11 illustrates an example method 1100 of wireless positioning, according to aspects of the disclosure. In an aspect, method 1100 may be performed by a wireless device (e.g., any of the wireless devices described herein).

At 1110, the wireless device receives one or more RF signals from a transmitter device (e.g., a “smart” keychain), as at the first stage of FIG. 6. In an aspect, operation 1110 may be performed by the one or more WWAN transceivers 310, the one or more processors 332, memory 340, and/or AoA estimator 342, any or all of which may be considered means for performing this operation.

At 1120, the wireless device displays one or more notifications on a user interface of the wireless device instructing a user of the wireless device to move the wireless device, as at the first and second stages of FIG. 7. In an aspect, operation 1120 may be performed by the one or more WWAN transceivers 310, the one or more processors 332, memory 340, and/or AoA estimator 342, any or all of which may be considered means for performing this operation.

At 1130, the wireless device determines an angle-of-arrival (AoA) of the one or more RF signals as corresponding to either a first AoA estimate of the one or more RF signals or a mirror AoA estimate of the first AoA estimate based on sensor data from one or more sensors of the wireless device, the sensor data indicating at least a direction of rotation of the wireless device caused by movement of the wireless device, as at the second stage of FIG. 7. In an aspect, operation 1130 may be performed by the one or more WWAN transceivers 310, the one or more processors 332, memory 340, and/or AoA estimator 342, any or all of which may be considered means for performing this operation.

At 1140, the wireless device displays an arrow on the user interface, a direction of the arrow representing the AoA of the one or more RF signals, as at the second, third, and fourth stages of FIG. 7. In an aspect, operation 1140 may be performed by the one or more WWAN transceivers 310, the one or more processors 332, memory 340, and/or AoA estimator 342, any or all of which may be considered means for performing this operation.

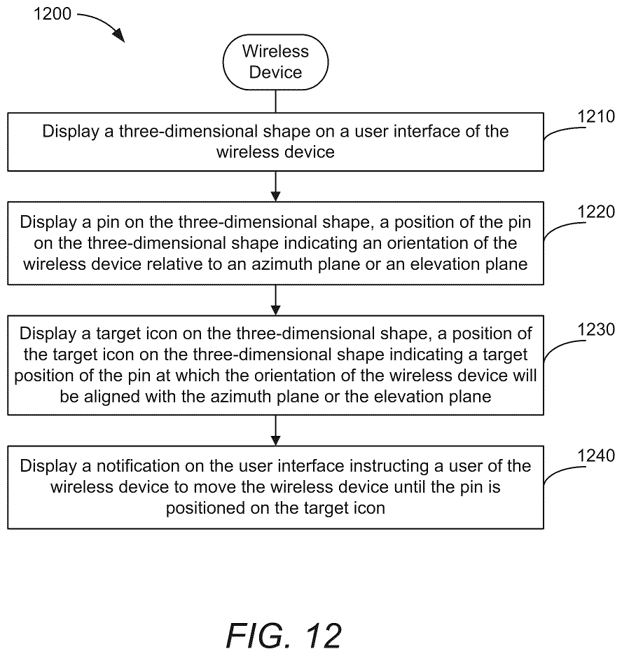

FIG. 12 illustrates an example method 1200 of wireless positioning, according to aspects of the disclosure. In an aspect, method 1200 may be performed by a wireless device (e.g., any of the wireless devices described herein).

At 1210, the wireless device displays a three-dimensional shape on a user interface of the wireless device, as at the first through fourth stages of FIGS. 8 and 9. In an aspect, operation 1210 may be performed by the one or more WWAN transceivers 310, the one or more processors 332, memory 340, and/or AoA estimator 342, any or all of which may be considered means for performing this operation.

At 1220, the wireless device displays a pin on the three-dimensional shape, a position of the pin on the three-dimensional shape indicating an orientation of the wireless device relative to an azimuth plane or an elevation plane, as at the first through fourth stages of FIGS. 8 and 9. In an aspect, operation 1220 may be performed by the one or more WWAN transceivers 310, the one or more processors 332, memory 340, and/or AoA estimator 342, any or all of which may be considered means for performing this operation.

At 1230, the wireless device displays a target icon on the three-dimensional shape, a position of the target icon on the three-dimensional shape indicating a target position of the pin at which the orientation of the wireless device will be aligned with the azimuth plane or the elevation plane, as at the first through fourth stages of FIGS. 8 and 9. In an aspect, operation 1230 may be performed by the one or more WWAN transceivers 310, the one or more processors 332, memory 340, and/or AoA estimator 342, any or all of which may be considered means for performing this operation.

At 1240, the wireless device displays a notification on the user interface instructing a user of the wireless device to move the wireless device until the pin is positioned on the target icon, as at the first and second stages of FIGS. 8 and 9. In an aspect, operation 1240 may be performed by the one or more WWAN transceivers 310, the one or more processors 332, memory 340, and/or AoA estimator 342, any or all of which may be considered means for performing this operation.

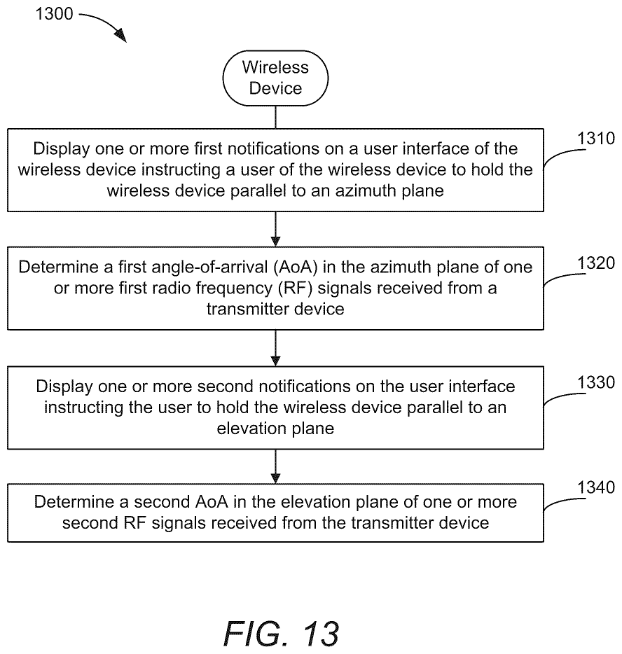

FIG. 13 illustrates an example method 1300 of wireless positioning, according to aspects of the disclosure. In an aspect, method 1300 may be performed by a wireless device (e.g., any of the wireless devices described herein).

At 1310, the wireless device displays one or more first notifications on a user interface of the wireless device instructing a user of the wireless device to hold the wireless device parallel to an azimuth plane. In an aspect, operation 1310 may be performed by the one or more WWAN transceivers 310, the one or more processors 332, memory 340, and/or AoA estimator 342, any or all of which may be considered means for performing this operation.

At 1320, the wireless device determines a first AoA in the azimuth plane of one or more first RF signals received from a transmitter device, as described with reference to FIG. 6. In an aspect, operation 1320 may be performed by the one or more WWAN transceivers 310, the one or more processors 332, memory 340, and/or AoA estimator 342, any or all of which may be considered means for performing this operation.

At 1330, the wireless device displays one or more second notifications on the user interface instructing the user to hold the wireless device parallel to an elevation plane. In an aspect, operation 1330 may be performed by the one or more WWAN transceivers 310, the one or more processors 332, memory 340, and/or AoA estimator 342, any or all of which may be considered means for performing this operation.

At 1340, the wireless device determines a second AoA in the elevation plane of one or more second RF signals received from the transmitter device, as described with reference to FIG. 6. In an aspect, operation 1340 may be performed by the one or more WWAN transceivers 310, the one or more processors 332, memory 340, and/or AoA estimator 342, any or all of which may be considered means for performing this operation.

As will be appreciated, a technical advantage of the methods 1000 to 1300 is improved AoA estimation for wireless devices with linear antenna arrays. More specifically, the methods 1000 to 1300 reduce or even eliminate the AoA ambiguity issue and provide 3D AoA estimation instead of 2D AoA estimation.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless positioning performed by a wireless device, comprising: receiving one or more radio frequency (RF) signals from a transmitter device; displaying a first arrow and a second arrow on a user interface of the wireless device, a direction of the first arrow representing a first angle-of-arrival (AoA) estimate of the one or more RF signals, and a direction of the second arrow representing a second AoA estimate of the one or more RF signals; and displaying one or more notifications on the user interface instructing a user of the wireless device to move the wireless device until the direction of the first arrow is aligned with the direction of the second arrow.

Clause 2. The method of clause 1, further comprising: determining the first AoA estimate and the second AoA estimate in response to reception of each of the one or more RF signals; and updating the direction of the first arrow and the direction of the second arrow in response to each determination of the first AoA estimate and the second AoA estimate.

Clause 3. The method of clause 2, wherein the first AoA estimate and the second AoA estimate are determined without using sensor data from the wireless device.

Clause 4. The method of any of clauses 1 to 3, further comprising: displaying an indication of a distance between the wireless device and the transmitter device.

Clause 5. The method of any of clauses 1 to 4, wherein the first AoA estimate and the second AoA estimate are based on reception of the one or more RF signals by a linear antenna array of the wireless device.

Clause 6. The method of any of clauses 1 to 5, wherein the first AoA estimate and the second AoA estimate are azimuth-only angles.

Clause 7. A method of wireless positioning performed by a wireless device, comprising: receiving one or more radio frequency (RF) signals from a transmitter device; displaying one or more notifications on a user interface of the wireless device instructing a user of the wireless device to move the wireless device; determining an angle-of-arrival (AoA) of the one or more RF signals as corresponding to either a first AoA estimate or a second AoA estimate of the one or more RF signals based on sensor data from one or more sensors of the wireless device, the sensor data indicating at least a direction of rotation of the wireless device caused by movement of the wireless device; and displaying an arrow on the user interface, a direction of the arrow representing the AoA of the one or more RF signals.

Clause 8. The method of clause 7, wherein the one or more sensors comprise a compass, one or more accelerometers, or any combination thereof.

Clause 9. The method of any of clauses 7 to 8, wherein: the one or more sensors comprise a compass, and the sensor data further indicates an amount of the rotation of the wireless device.

Clause 10. The method of any of clauses 7 to 9, further comprising: displaying a first arrow and a second arrow on the user interface until the AoA of the one or more RF signals is determined and the arrow is displayed, a direction of the first arrow representing the first AoA estimate and a direction of the second arrow representing the second AoA estimate.

Clause 11. The method of any of clauses 7 to 10, further comprising: displaying an indication of a distance between the wireless device and the transmitter device.

Clause 12. The method of any of clauses 7 to 11, wherein the first AoA estimate and the second AoA estimate are based on reception of the one or more RF signals by a linear antenna array of the wireless device.

Clause 13. The method of any of clauses 7 to 12, wherein the first AoA estimate and the second AoA estimate are azimuth-only angles.

Clause 14. A method of wireless positioning performed by a wireless device, comprising: displaying a three-dimensional shape on a user interface of the wireless device; displaying a pin on the three-dimensional shape, a position of the pin on the three-dimensional shape indicating an orientation of the wireless device relative to an azimuth plane or an elevation plane; displaying a target icon on the three-dimensional shape, a position of the target icon on the three-dimensional shape indicating a target position of the pin at which the orientation of the wireless device will be aligned with the azimuth plane or the elevation plane; and displaying a notification on the user interface instructing a user of the wireless device to move the wireless device until the pin is positioned on the target icon.

Clause 15. The method of clause 14, wherein: the target position of the pin is at a top of the three-dimensional shape, and the target position of the pin being at the top of the three-dimensional shape indicates that the orientation of the wireless device will be aligned with the azimuth plane.

Clause 16. The method of clause 14, wherein: the target position of the pin is at a middle of the three-dimensional shape, and the target position of the pin being at the middle of the three-dimensional shape indicates that the orientation of the wireless device will be aligned with the elevation plane.

Clause 17. The method of any of clauses 14 to 16, wherein: the position of the pin on the three-dimensional shape indicates the orientation of the wireless device relative to the azimuth plane, and the position of the target icon on the three-dimensional shape indicates the target position of the pin at which the orientation of the wireless device will be aligned with the azimuth plane.

Clause 18. The method of clause 17, further comprising: receiving one or more radio frequency (RF) signals from a transmitter device; and determining an angle-of-arrival (AoA) in the azimuth plane of the one or more RF signals.

Clause 19. The method of clause 18, wherein determining the AoA comprises: displaying a first arrow and a second arrow on the user interface, a direction of the first arrow representing a first AoA estimate in the azimuth plane of the one or more RF signals, and a direction of the second arrow representing a second AoA estimate in the azimuth plane of the one or more RF signals; and displaying one or more notifications on the user interface instructing the user to move the wireless device until the direction of the first arrow is aligned with the direction of the second arrow.

Clause 20. The method of clause 18, wherein determining the AoA comprises: displaying one or more notifications on the user interface instructing the user to move the wireless device; determining an AoA of the one or more RF signals as corresponding to either a first AoA estimate or a second AoA estimate of the one or more RF signals in the azimuth plane based on sensor data from one or more sensors of the wireless device, the sensor data indicating at least a direction of rotation of the wireless device caused by movement of the wireless device; and displaying an arrow on the user interface, a direction of the arrow representing the AoA of the one or more RF signals.

Clause 21. The method of any of clauses 17 to 20, further comprising: displaying a second pin on the three-dimensional shape, a position of the second pin on the three-dimensional shape indicating the orientation of the wireless device relative to the elevation plane; displaying a second target icon on the three-dimensional shape, a position of the second target icon on the three-dimensional shape indicating a second target position of the pin at which the orientation of the wireless device will be aligned with the elevation plane; and displaying a second notification on the user interface instructing the user of the wireless device to move the wireless device until the second pin is positioned on the second target icon.

Clause 22. The method of clause 21, further comprising: receiving one or more RF signals from a transmitter device; and determining an AoA in the elevation plane of the one or more RF signals.

Clause 23. The method of clause 22, wherein determining the AoA comprises: displaying a first arrow and a second arrow on the user interface, a direction of the first arrow representing a first AoA estimate in the elevation plane of the one or more RF signals, and a direction of the second arrow representing a second AoA estimate in the elevation plane of the one or more RF signals; and displaying one or more notifications on the user interface instructing the user to move the wireless device until the direction of the first arrow is aligned with the direction of the second arrow.

Clause 24. The method of clause 22, wherein determining the AoA comprises: displaying one or more notifications on the user interface instructing the user to move the wireless device; determining the AoA of the one or more RF signals as corresponding to either a first AoA estimate or a second AoA estimate of the one or more RF signals in the elevation plane based on sensor data from one or more sensors of the wireless device, the sensor data indicating at least a direction of rotation of the wireless device caused by movement of the wireless device; and displaying an arrow on the user interface, a direction of the arrow representing the AoA of the one or more RF signals.

Clause 25. The method of any of clauses 14 to 24, wherein the three-dimensional shape is a sphere or a half sphere.

Clause 26. A method of wireless positioning performed by a wireless device, comprising: displaying one or more first notifications on a user interface of the wireless device instructing a user of the wireless device to hold the wireless device parallel to an azimuth plane; determining a first angle-of-arrival (AoA) in the azimuth plane of one or more first radio frequency (RF) signals received from a transmitter device; displaying one or more second notifications on the user interface instructing the user to hold the wireless device parallel to an elevation plane; and determining a second AoA in the elevation plane of one or more second RF signals received from the transmitter device.

Clause 27. The method of clause 26, wherein: the one or more first notifications include at least one first reminder to the user to hold the wireless device parallel to the azimuth plane, the one or more second notifications include at least one second reminder to the user to hold the wireless device parallel to the elevation plane.

Clause 28. The method of any of clauses 26 to 27, wherein the first AoA and the second AoA are determined without using sensor data from the wireless device.

Clause 29. The method of any of clauses 26 to 28, wherein the first AoA and the second AoA are determined based on reception of the one or more first RF signals and the one or more second RF signals, respectively, by a linear antenna array of the wireless device.

Clause 30. The method of any of clauses 26 to 29, wherein determining the first AoA comprises: displaying a first arrow and a second arrow on the user interface, a direction of the first arrow representing a first AoA estimate in the azimuth plane of the one or more RF signals, and a direction of the second arrow representing a second AoA estimate in the azimuth plane of the one or more RF signals; and displaying one or more notifications on the user interface instructing the user to move the wireless device until the direction of the first arrow is aligned with the direction of the second arrow.

Clause 31. The method of any of clauses 26 to 30, wherein determining the second AoA comprises: displaying a first arrow and a second arrow on the user interface, a direction of the first arrow representing a first AoA estimate in the elevation plane of the one or more RF signals, and a direction of the second arrow representing a second AoA estimate in the elevation plane of the one or more RF signals; and displaying one or more notifications on the user interface instructing the user to move the wireless device until the direction of the first arrow is aligned with the direction of the second arrow.

Clause 32. A wireless device, comprising: a memory; at least one transceiver; and at least one processor communicatively coupled to the memory and the at least one transceiver, the at least one processor configured to: receive, via the at least one transceiver, one or more radio frequency (RF) signals from a transmitter device; display a first arrow and a second arrow on a user interface of the wireless device, a direction of the first arrow representing a first angle-of-arrival (AoA) estimate of the one or more RF signals, and a direction of the second arrow representing a second AoA estimate of the one or more RF signals; and display one or more notifications on the user interface instructing a user of the wireless device to move the wireless device until the direction of the first arrow is aligned with the direction of the second arrow.

Clause 33. The wireless device of clause 32, wherein the at least one processor is further configured to: determine the first AoA estimate and the second AoA estimate in response to reception of each of the one or more RF signals; and update the direction of the first arrow and the direction of the second arrow in response to each determination of the first AoA estimate and the second AoA estimate.

Clause 34. The wireless device of clause 33, wherein the first AoA estimate and the second AoA estimate are determined without using sensor data from the wireless device.

Clause 35. The wireless device of any of clauses 32 to 34, wherein the at least one processor is further configured to: display an indication of a distance between the wireless device and the transmitter device.

Clause 36. The wireless device of any of clauses 32 to 35, wherein the first AoA estimate and the second AoA estimate are based on reception of the one or more RF signals by a linear antenna array of the wireless device.

Clause 37. The wireless device of any of clauses 32 to 36, wherein the first AoA estimate and the second AoA estimate are azimuth-only angles.

Clause 38. A wireless device, comprising: a memory; at least one transceiver; and at least one processor communicatively coupled to the memory and the at least one transceiver, the at least one processor configured to: receive, via the at least one transceiver, one or more radio frequency (RF) signals from a transmitter device; display one or more notifications on a user interface of the wireless device instructing a user of the wireless device to move the wireless device; determine an angle-of-arrival (AoA) of the one or more RF signals as corresponding to either a first AoA estimate or a second AoA estimate of the one or more RF signals based on sensor data from one or more sensors of the wireless device, the sensor data indicating at least a direction of rotation of the wireless device caused by movement of the wireless device; and display an arrow on the user interface, a direction of the arrow representing the AoA of the one or more RF signals.

Clause 39. The wireless device of clause 38, wherein the one or more sensors comprise a compass, one or more accelerometers, or any combination thereof.

Clause 40. The wireless device of any of clauses 38 to 39, wherein: the one or more sensors comprise a compass, and the sensor data further indicates an amount of the rotation of the wireless device.

Clause 41. The wireless device of any of clauses 38 to 40, wherein the at least one processor is further configured to: display a first arrow and a second arrow on the user interface until the AoA of the one or more RF signals is determined and the arrow is displayed, a direction of the first arrow representing the first AoA estimate and a direction of the second arrow representing the second AoA estimate.

Clause 42. The wireless device of any of clauses 38 to 41, wherein the at least one processor is further configured to: display an indication of a distance between the wireless device and the transmitter device.

Clause 43. The wireless device of any of clauses 38 to 42, wherein the first AoA estimate and the second AoA estimate are based on reception of the one or more RF signals by a linear antenna array of the wireless device.

Clause 44. The wireless device of any of clauses 38 to 43, wherein the first AoA estimate and the second AoA estimate are azimuth-only angles.

Clause 45. A wireless device, comprising: a memory; at least one transceiver; and at least one processor communicatively coupled to the memory and the at least one transceiver, the at least one processor configured to: display a three-dimensional shape on a user interface of the wireless device; display a pin on the three-dimensional shape, a position of the pin on the three-dimensional shape indicating an orientation of the wireless device relative to an azimuth plane or an elevation plane; display a target icon on the three-dimensional shape, a position of the target icon on the three-dimensional shape indicating a target position of the pin at which the orientation of the wireless device will be aligned with the azimuth plane or the elevation plane; and display a notification on the user interface instructing a user of the wireless device to move the wireless device until the pin is positioned on the target icon.

Clause 46. The wireless device of clause 45, wherein: the target position of the pin is at a top of the three-dimensional shape, and the target position of the pin being at the top of the three-dimensional shape indicates that the orientation of the wireless device will be aligned with the azimuth plane.

Clause 47. The wireless device of clause 45, wherein: the target position of the pin is at a middle of the three-dimensional shape, and the target position of the pin being at the middle of the three-dimensional shape indicates that the orientation of the wireless device will be aligned with the elevation plane.

Clause 48. The wireless device of any of clauses 45 to 47, wherein: the position of the pin on the three-dimensional shape indicates the orientation of the wireless device relative to the azimuth plane, and the position of the target icon on the three-dimensional shape indicates the target position of the pin at which the orientation of the wireless device will be aligned with the azimuth plane.

Clause 49. The wireless device of clause 48, wherein the at least one processor is further configured to: receive, via the at least one transceiver, one or more radio frequency (RF) signals from a transmitter device; and determine an angle-of-arrival (AoA) in the azimuth plane of the one or more RF signals.

Clause 50. The wireless device of clause 49, wherein the at least one processor configured to determine the AoA comprises the at least one processor configured to: display a first arrow and a second arrow on the user interface, a direction of the first arrow representing a first AoA estimate in the azimuth plane of the one or more RF signals, and a direction of the second arrow representing a second AoA estimate in the azimuth plane of the one or more RF signals; and display one or more notifications on the user interface instructing the user to move the wireless device until the direction of the first arrow is aligned with the direction of the second arrow.

Clause 51. The wireless device of clause 49, wherein the at least one processor configured to determine the AoA comprises the at least one processor configured to: display one or more notifications on the user interface instructing the user to move the wireless device; determine an AoA of the one or more RF signals as corresponding to either a first AoA estimate or a second AoA estimate of the one or more RF signals in the azimuth plane based on sensor data from one or more sensors of the wireless device, the sensor data indicating at least a direction of rotation of the wireless device caused by movement of the wireless device; and display an arrow on the user interface, a direction of the arrow representing the AoA of the one or more RF signals.

Clause 52. The wireless device of any of clauses 48 to 51, wherein the at least one processor is further configured to: display a second pin on the three-dimensional shape, a position of the second pin on the three-dimensional shape indicating the orientation of the wireless device relative to the elevation plane; display a second target icon on the three-dimensional shape, a position of the second target icon on the three-dimensional shape indicating a second target position of the pin at which the orientation of the wireless device will be aligned with the elevation plane; and display a second notification on the user interface instructing the user of the wireless device to move the wireless device until the second pin is positioned on the second target icon.

Clause 53. The wireless device of clause 52, wherein the at least one processor is further configured to: receive, via the at least one transceiver, one or more RF signals from a transmitter device; and determine an AoA in the elevation plane of the one or more RF signals.

Clause 54. The wireless device of clause 53, wherein the at least one processor configured to determine the AoA comprises the at least one processor configured to: display a first arrow and a second arrow on the user interface, a direction of the first arrow representing a first AoA estimate in the elevation plane of the one or more RF signals, and a direction of the second arrow representing a second AoA estimate in the elevation plane of the one or more RF signals; and display one or more notifications on the user interface instructing the user to move the wireless device until the direction of the first arrow is aligned with the direction of the second arrow.

Clause 55. The wireless device of clause 53, wherein the at least one processor configured to determine the AoA comprises the at least one processor configured to: display one or more notifications on the user interface instructing the user to move the wireless device; determine the AoA of the one or more RF signals as corresponding to either a first AoA estimate or a second AoA estimate of the one or more RF signals in the elevation plane based on sensor data from one or more sensors of the wireless device, the sensor data indicating at least a direction of rotation of the wireless device caused by movement of the wireless device; and display an arrow on the user interface, a direction of the arrow representing the AoA of the one or more RF signals.

Clause 56. The wireless device of any of clauses 45 to 55, wherein the three-dimensional shape is a sphere or a half sphere.

Clause 57. A wireless device, comprising: a memory; at least one transceiver; and at least one processor communicatively coupled to the memory and the at least one transceiver, the at least one processor configured to: display one or more first notifications on a user interface of the wireless device instructing a user of the wireless device to hold the wireless device parallel to an azimuth plane; determine a first angle-of-arrival (AoA) in the azimuth plane of one or more first radio frequency (RF) signals received from a transmitter device; display one or more second notifications on the user interface instructing the user to hold the wireless device parallel to an elevation plane; and determine a second AoA in the elevation plane of one or more second RF signals received from the transmitter device.

Clause 58. The wireless device of clause 57, wherein: the one or more first notifications include at least one first reminder to the user to hold the wireless device parallel to the azimuth plane, the one or more second notifications include at least one second reminder to the user to hold the wireless device parallel to the elevation plane.

Clause 59. The wireless device of any of clauses 57 to 58, wherein the first AoA and the second AoA are determined without using sensor data from the wireless device.

Clause 60. The wireless device of any of clauses 57 to 59, wherein the first AoA and the second AoA are determined based on reception of the one or more first RF signals and the one or more second RF signals, respectively, by a linear antenna array of the wireless device.

Clause 61. The wireless device of any of clauses 57 to 60, wherein the at least one processor configured to determine the first AoA comprises the at least one processor configured to: display a first arrow and a second arrow on the user interface, a direction of the first arrow representing a first AoA estimate in the azimuth plane of the one or more RF signals, and a direction of the second arrow representing a second AoA estimate in the azimuth plane of the one or more RF signals; and display one or more notifications on the user interface instructing the user to move the wireless device until the direction of the first arrow is aligned with the direction of the second arrow.

Clause 62. The wireless device of any of clauses 57 to 61, wherein the at least one processor configured to determine the second AoA comprises the at least one processor configured to: display a first arrow and a second arrow on the user interface, a direction of the first arrow representing a first AoA estimate in the elevation plane of the one or more RF signals, and a direction of the second arrow representing a second AoA estimate in the elevation plane of the one or more RF signals; and display one or more notifications on the user interface instructing the user to move the wireless device until the direction of the first arrow is aligned with the direction of the second arrow.

Clause 63. A wireless device, comprising: means for receiving one or more radio frequency (RF) signals from a transmitter device; means for displaying a first arrow and a second arrow on a user interface of the wireless device, a direction of the first arrow representing a first angle-of-arrival (AoA) estimate of the one or more RF signals, and a direction of the second arrow representing a second AoA estimate of the one or more RF signals; and means for displaying one or more notifications on the user interface instructing a user of the wireless device to move the wireless device until the direction of the first arrow is aligned with the direction of the second arrow.

Clause 64. The wireless device of clause 63, further comprising: means for determining the first AoA estimate and the second AoA estimate in response to reception of each of the one or more RF signals; and means for updating the direction of the first arrow and the direction of the second arrow in response to each determination of the first AoA estimate and the second AoA estimate.

Clause 65. The wireless device of clause 64, wherein the first AoA estimate and the second AoA estimate are determined without using sensor data from the wireless device.

Clause 66. The wireless device of any of clauses 63 to 65, further comprising: means for displaying an indication of a distance between the wireless device and the transmitter device.

Clause 67. The wireless device of any of clauses 63 to 66, wherein the first AoA estimate and the second AoA estimate are based on reception of the one or more RF signals by a linear antenna array of the wireless device.

Clause 68. The wireless device of any of clauses 63 to 67, wherein the first AoA estimate and the second AoA estimate are azimuth-only angles.

Clause 69. A wireless device, comprising: means for receiving one or more radio frequency (RF) signals from a transmitter device; means for displaying one or more notifications on a user interface of the wireless device instructing a user of the wireless device to move the wireless device; means for determining an angle-of-arrival (AoA) of the one or more RF signals as corresponding to either a first AoA estimate or a second AoA estimate of the one or more RF signals based on sensor data from one or more sensors of the wireless device, the sensor data indicating at least a direction of rotation of the wireless device caused by movement of the wireless device; and means for displaying an arrow on the user interface, a direction of the arrow representing the AoA of the one or more RF signals.

Clause 70. The wireless device of clause 69, wherein the one or more sensors comprise a compass, one or more accelerometers, or any combination thereof.

Clause 71. The wireless device of any of clauses 69 to 70, wherein: the one or more sensors comprise a compass, and the sensor data further indicates an amount of the rotation of the wireless device.

Clause 72. The wireless device of any of clauses 69 to 71, further comprising: means for displaying a first arrow and a second arrow on the user interface until the AoA of the one or more RF signals is determined and the arrow is displayed, a direction of the first arrow representing the first AoA estimate and a direction of the second arrow representing the second AoA estimate.

Clause 73. The wireless device of any of clauses 69 to 72, further comprising: means for displaying an indication of a distance between the wireless device and the transmitter device.

Clause 74. The wireless device of any of clauses 69 to 73, wherein the first AoA estimate and the second AoA estimate are based on reception of the one or more RF signals by a linear antenna array of the wireless device.

Clause 75. The wireless device of any of clauses 69 to 74, wherein the first AoA estimate and the second AoA estimate are azimuth-only angles.

Clause 76. A wireless device, comprising: means for displaying a three-dimensional shape on a user interface of the wireless device; means for displaying a pin on the three-dimensional shape, a position of the pin on the three-dimensional shape indicating an orientation of the wireless device relative to an azimuth plane or an elevation plane; means for displaying a target icon on the three-dimensional shape, a position of the target icon on the three-dimensional shape indicating a target position of the pin at which the orientation of the wireless device will be aligned with the azimuth plane or the elevation plane; and means for displaying a notification on the user interface instructing a user of the wireless device to move the wireless device until the pin is positioned on the target icon.

Clause 77. The wireless device of clause 76, wherein: the target position of the pin is at a top of the three-dimensional shape, and the target position of the pin being at the top of the three-dimensional shape indicates that the orientation of the wireless device will be aligned with the azimuth plane.

Clause 78. The wireless device of clause 76, wherein: the target position of the pin is at a middle of the three-dimensional shape, and the target position of the pin being at the middle of the three-dimensional shape indicates that the orientation of the wireless device will be aligned with the elevation plane.

Clause 79. The wireless device of any of clauses 76 to 78, wherein: the position of the pin on the three-dimensional shape indicates the orientation of the wireless device relative to the azimuth plane, and the position of the target icon on the three-dimensional shape indicates the target position of the pin at which the orientation of the wireless device will be aligned with the azimuth plane.

Clause 80. The wireless device of clause 79, further comprising: means for receiving one or more radio frequency (RF) signals from a transmitter device; and means for determining an angle-of-arrival (AoA) in the azimuth plane of the one or more RF signals.

Clause 81. The wireless device of clause 80, wherein the means for determining the AoA comprises: means for displaying a first arrow and a second arrow on the user interface, a direction of the first arrow representing a first AoA estimate in the azimuth plane of the one or more RF signals, and a direction of the second arrow representing a second AoA estimate in the azimuth plane of the one or more RF signals; and means for displaying one or more notifications on the user interface instructing the user to move the wireless device until the direction of the first arrow is aligned with the direction of the second arrow.

Clause 82. The wireless device of clause 80, wherein the means for determining the AoA comprises: means for displaying one or more notifications on the user interface instructing the user to move the wireless device; means for determining an AoA of the one or more RF signals as corresponding to either a first AoA estimate or a second AoA estimate of the one or more RF signals in the azimuth plane based on sensor data from one or more sensors of the wireless device, the sensor data indicating at least a direction of rotation of the wireless device caused by movement of the wireless device; and means for displaying an arrow on the user interface, a direction of the arrow representing the AoA of the one or more RF signals.

Clause 83. The wireless device of any of clauses 79 to 82, further comprising: means for displaying a second pin on the three-dimensional shape, a position of the second pin on the three-dimensional shape indicating the orientation of the wireless device relative to the elevation plane; means for displaying a second target icon on the three-dimensional shape, a position of the second target icon on the three-dimensional shape indicating a second target position of the pin at which the orientation of the wireless device will be aligned with the elevation plane; and means for displaying a second notification on the user interface instructing the user of the wireless device to move the wireless device until the second pin is positioned on the second target icon.

Clause 84. The wireless device of clause 83, further comprising: means for receiving one or more RF signals from a transmitter device; and means for determining an AoA in the elevation plane of the one or more RF signals.

Clause 85. The wireless device of clause 84, wherein the means for determining the AoA comprises: means for displaying a first arrow and a second arrow on the user interface, a direction of the first arrow representing a first AoA estimate in the elevation plane of the one or more RF signals, and a direction of the second arrow representing a second AoA estimate in the elevation plane of the one or more RF signals; and means for displaying one or more notifications on the user interface instructing the user to move the wireless device until the direction of the first arrow is aligned with the direction of the second arrow.

Clause 86. The wireless device of clause 84, wherein the means for determining the AoA comprises: means for displaying one or more notifications on the user interface instructing the user to move the wireless device; means for determining the AoA of the one or more RF signals as corresponding to either a first AoA estimate or a second AoA estimate of the one or more RF signals in the elevation plane based on sensor data from one or more sensors of the wireless device, the sensor data indicating at least a direction of rotation of the wireless device caused by movement of the wireless device; and means for displaying an arrow on the user interface, a direction of the arrow representing the AoA of the one or more RF signals.

Clause 87. The wireless device of any of clauses 76 to 86, wherein the three-dimensional shape is a sphere or a half sphere.

Clause 88. A wireless device, comprising: means for displaying one or more first notifications on a user interface of the wireless device instructing a user of the wireless device to hold the wireless device parallel to an azimuth plane; means for determining a first angle-of-arrival (AoA) in the azimuth plane of one or more first radio frequency (RF) signals received from a transmitter device; means for displaying one or more second notifications on the user interface instructing the user to hold the wireless device parallel to an elevation plane; and means for determining a second AoA in the elevation plane of one or more second RF signals received from the transmitter device.

Clause 89. The wireless device of clause 88, wherein: the one or more first notifications include at least one first reminder to the user to hold the wireless device parallel to the azimuth plane, the one or more second notifications include at least one second reminder to the user to hold the wireless device parallel to the elevation plane.

Clause 90. The wireless device of any of clauses 88 to 89, wherein the first AoA and the second AoA are determined without using sensor data from the wireless device.

Clause 91. The wireless device of any of clauses 88 to 90, wherein the first AoA and the second AoA are determined based on reception of the one or more first RF signals and the one or more second RF signals, respectively, by a linear antenna array of the wireless device.

Clause 92. The wireless device of any of clauses 88 to 91, wherein the means for determining the first AoA comprises: means for displaying a first arrow and a second arrow on the user interface, a direction of the first arrow representing a first AoA estimate in the azimuth plane of the one or more RF signals, and a direction of the second arrow representing a second AoA estimate in the azimuth plane of the one or more RF signals; and means for displaying one or more notifications on the user interface instructing the user to move the wireless device until the direction of the first arrow is aligned with the direction of the second arrow.

Clause 93. The wireless device of any of clauses 88 to 92, wherein the means for determining the second AoA comprises: means for displaying a first arrow and a second arrow on the user interface, a direction of the first arrow representing a first AoA estimate in the elevation plane of the one or more RF signals, and a direction of the second arrow representing a second AoA estimate in the elevation plane of the one or more RF signals; and means for displaying one or more notifications on the user interface instructing the user to move the wireless device until the direction of the first arrow is aligned with the direction of the second arrow.

Clause 94. A non-transitory computer-readable medium storing computer-executable instructions that, when executed by a wireless device, cause the wireless device to: receive one or more radio frequency (RF) signals from a transmitter device; display a first arrow and a second arrow on a user interface of the wireless device, a direction of the first arrow representing a first angle-of-arrival (AoA) estimate of the one or more RF signals, and a direction of the second arrow representing a second AoA estimate of the one or more RF signals; and display one or more notifications on the user interface instructing a user of the wireless device to move the wireless device until the direction of the first arrow is aligned with the direction of the second arrow.

Clause 95. The non-transitory computer-readable medium of clause 94, further comprising computer-executable instructions that, when executed by the wireless device, cause the wireless device to: determine the first AoA estimate and the second AoA estimate in response to reception of each of the one or more RF signals; and update the direction of the first arrow and the direction of the second arrow in response to each determination of the first AoA estimate and the second AoA estimate.

Clause 96. The non-transitory computer-readable medium of clause 95, wherein the first AoA estimate and the second AoA estimate are determined without using sensor data from the wireless device.

Clause 97. The non-transitory computer-readable medium of any of clauses 94 to 96, further comprising computer-executable instructions that, when executed by the wireless device, cause the wireless device to: display an indication of a distance between the wireless device and the transmitter device.

Clause 98. The non-transitory computer-readable medium of any of clauses 94 to 97, wherein the first AoA estimate and the second AoA estimate are based on reception of the one or more RF signals by a linear antenna array of the wireless device.

Clause 99. The non-transitory computer-readable medium of any of clauses 94 to 98, wherein the first AoA estimate and the second AoA estimate are azimuth-only angles.

Clause 100. A non-transitory computer-readable medium storing computer-executable instructions that, when executed by a wireless device, cause the wireless device to: receive one or more radio frequency (RF) signals from a transmitter device; display one or more notifications on a user interface of the wireless device instructing a user of the wireless device to move the wireless device; determine an angle-of-arrival (AoA) of the one or more RF signals as corresponding to either a first AoA estimate or a second AoA estimate of the one or more RF signals based on sensor data from one or more sensors of the wireless device, the sensor data indicating at least a direction of rotation of the wireless device caused by movement of the wireless device; and display an arrow on the user interface, a direction of the arrow representing the AoA of the one or more RF signals.

Clause 101. The non-transitory computer-readable medium of clause 100, wherein the one or more sensors comprise a compass, one or more accelerometers, or any combination thereof.

Clause 102. The non-transitory computer-readable medium of any of clauses 100 to 101, wherein: the one or more sensors comprise a compass, and the sensor data further indicates an amount of the rotation of the wireless device.

Clause 103. The non-transitory computer-readable medium of any of clauses 100 to 102, further comprising computer-executable instructions that, when executed by the wireless device, cause the wireless device to: display a first arrow and a second arrow on the user interface until the AoA of the one or more RF signals is determined and the arrow is displayed, a direction of the first arrow representing the first AoA estimate and a direction of the second arrow representing the second AoA estimate.

Clause 104. The non-transitory computer-readable medium of any of clauses 100 to 103, further comprising computer-executable instructions that, when executed by the wireless device, cause the wireless device to: display an indication of a distance between the wireless device and the transmitter device.

Clause 105. The non-transitory computer-readable medium of any of clauses 100 to 104, wherein the first AoA estimate and the second AoA estimate are based on reception of the one or more RF signals by a linear antenna array of the wireless device.

Clause 106. The non-transitory computer-readable medium of any of clauses 100 to 105, wherein the first AoA estimate and the second AoA estimate are azimuth-only angles.

Clause 107. A non-transitory computer-readable medium storing computer-executable instructions that, when executed by a wireless device, cause the wireless device to: display a three-dimensional shape on a user interface of the wireless device; display a pin on the three-dimensional shape, a position of the pin on the three-dimensional shape indicating an orientation of the wireless device relative to an azimuth plane or an elevation plane; display a target icon on the three-dimensional shape, a position of the target icon on the three-dimensional shape indicating a target position of the pin at which the orientation of the wireless device will be aligned with the azimuth plane or the elevation plane; and display a notification on the user interface instructing a user of the wireless device to move the wireless device until the pin is positioned on the target icon.

Clause 108. The non-transitory computer-readable medium of clause 107, wherein: the target position of the pin is at a top of the three-dimensional shape, and the target position of the pin being at the top of the three-dimensional shape indicates that the orientation of the wireless device will be aligned with the azimuth plane.

Clause 109. The non-transitory computer-readable medium of clause 107, wherein: the target position of the pin is at a middle of the three-dimensional shape, and the target position of the pin being at the middle of the three-dimensional shape indicates that the orientation of the wireless device will be aligned with the elevation plane.

Clause 110. The non-transitory computer-readable medium of any of clauses 107 to 109, wherein: the position of the pin on the three-dimensional shape indicates the orientation of the wireless device relative to the azimuth plane, and the position of the target icon on the three-dimensional shape indicates the target position of the pin at which the orientation of the wireless device will be aligned with the azimuth plane.

Clause 111. The non-transitory computer-readable medium of clause 110, further comprising computer-executable instructions that, when executed by the wireless device, cause the wireless device to: receive one or more radio frequency (RF) signals from a transmitter device; and determine an angle-of-arrival (AoA) in the azimuth plane of the one or more RF signals.

Clause 112. The non-transitory computer-readable medium of clause 111, wherein the computer-executable instructions that, when executed by the wireless device, cause the wireless device to determine the AoA comprise computer-executable instructions that, when executed by the wireless device, cause the wireless device to: display a first arrow and a second arrow on the user interface, a direction of the first arrow representing a first AoA estimate in the azimuth plane of the one or more RF signals, and a direction of the second arrow representing a second AoA estimate in the azimuth plane of the one or more RF signals; and display one or more notifications on the user interface instructing the user to move the wireless device until the direction of the first arrow is aligned with the direction of the second arrow.

Clause 113. The non-transitory computer-readable medium of clause 111, wherein the computer-executable instructions that, when executed by the wireless device, cause the wireless device to determine the AoA comprise computer-executable instructions that, when executed by the wireless device, cause the wireless device to: display one or more notifications on the user interface instructing the user to move the wireless device; determine an AoA of the one or more RF signals as corresponding to either a first AoA estimate or a second AoA estimate of the one or more RF signals in the azimuth plane based on sensor data from one or more sensors of the wireless device, the sensor data indicating at least a direction of rotation of the wireless device caused by movement of the wireless device; and display an arrow on the user interface, a direction of the arrow representing the AoA of the one or more RF signals.

Clause 114. The non-transitory computer-readable medium of any of clauses 110 to 113, further comprising computer-executable instructions that, when executed by the wireless device, cause the wireless device to: display a second pin on the three-dimensional shape, a position of the second pin on the three-dimensional shape indicating the orientation of the wireless device relative to the elevation plane; display a second target icon on the three-dimensional shape, a position of the second target icon on the three-dimensional shape indicating a second target position of the pin at which the orientation of the wireless device will be aligned with the elevation plane; and display a second notification on the user interface instructing the user of the wireless device to move the wireless device until the second pin is positioned on the second target icon.

Clause 115. The non-transitory computer-readable medium of clause 114, further comprising computer-executable instructions that, when executed by the wireless device, cause the wireless device to: receive one or more RF signals from a transmitter device; and determine an AoA in the elevation plane of the one or more RF signals.

Clause 116. The non-transitory computer-readable medium of clause 115, wherein the computer-executable instructions that, when executed by the wireless device, cause the wireless device to determine the AoA comprise computer-executable instructions that, when executed by the wireless device, cause the wireless device to: display a first arrow and a second arrow on the user interface, a direction of the first arrow representing a first AoA estimate in the elevation plane of the one or more RF signals, and a direction of the second arrow representing a second AoA estimate in the elevation plane of the one or more RF signals; and display one or more notifications on the user interface instructing the user to move the wireless device until the direction of the first arrow is aligned with the direction of the second arrow.

Clause 117. The non-transitory computer-readable medium of clause 115, wherein the computer-executable instructions that, when executed by the wireless device, cause the wireless device to determine the AoA comprise computer-executable instructions that, when executed by the wireless device, cause the wireless device to: display one or more notifications on the user interface instructing the user to move the wireless device; determine the AoA of the one or more RF signals as corresponding to either a first AoA estimate or a second AoA estimate of the one or more RF signals in the elevation plane based on sensor data from one or more sensors of the wireless device, the sensor data indicating at least a direction of rotation of the wireless device caused by movement of the wireless device; and display an arrow on the user interface, a direction of the arrow representing the AoA of the one or more RF signals.

Clause 118. The non-transitory computer-readable medium of any of clauses 107 to 117, wherein the three-dimensional shape is a sphere or a half sphere.

Clause 119. A non-transitory computer-readable medium storing computer-executable instructions that, when executed by a wireless device, cause the wireless device to: display one or more first notifications on a user interface of the wireless device instructing a user of the wireless device to hold the wireless device parallel to an azimuth plane; determine a first angle-of-arrival (AoA) in the azimuth plane of one or more first radio frequency (RF) signals received from a transmitter device; display one or more second notifications on the user interface instructing the user to hold the wireless device parallel to an elevation plane; and determine a second AoA in the elevation plane of one or more second RF signals received from the transmitter device.

Clause 120. The non-transitory computer-readable medium of clause 119, wherein: the one or more first notifications include at least one first reminder to the user to hold the wireless device parallel to the azimuth plane, the one or more second notifications include at least one second reminder to the user to hold the wireless device parallel to the elevation plane.

Clause 121. The non-transitory computer-readable medium of any of clauses 119 to 120, wherein the first AoA and the second AoA are determined without using sensor data from the wireless device.

Clause 122. The non-transitory computer-readable medium of any of clauses 119 to 121, wherein the first AoA and the second AoA are determined based on reception of the one or more first RF signals and the one or more second RF signals, respectively, by a linear antenna array of the wireless device.

Clause 123. The non-transitory computer-readable medium of any of clauses 119 to 122, wherein the computer-executable instructions that, when executed by the wireless device, cause the wireless device to determine the first AoA comprise computer-executable instructions that, when executed by the wireless device, cause the wireless device to: display a first arrow and a second arrow on the user interface, a direction of the first arrow representing a first AoA estimate in the azimuth plane of the one or more RF signals, and a direction of the second arrow representing a second AoA estimate in the azimuth plane of the one or more RF signals; and display one or more notifications on the user interface instructing the user to move the wireless device until the direction of the first arrow is aligned with the direction of the second arrow.

Clause 124. The non-transitory computer-readable medium of any of clauses 119 to 123, wherein the computer-executable instructions that, when executed by the wireless device, cause the wireless device to determine the second AoA comprise computer-executable instructions that, when executed by the wireless device, cause the wireless device to: display a first arrow and a second arrow on the user interface, a direction of the first arrow representing a first AoA estimate in the elevation plane of the one or more RF signals, and a direction of the second arrow representing a second AoA estimate in the elevation plane of the one or more RF signals; and display one or more notifications on the user interface instructing the user to move the wireless device until the direction of the first arrow is aligned with the direction of the second arrow.

Additional implementation examples are described in the following numbered clauses:

Clause 1. A method of wireless positioning performed by a wireless device, comprising: receiving one or more radio frequency (RF) signals from a transmitter device; displaying a first arrow and a second arrow on a user interface of the wireless device, a direction of the first arrow representing a first angle-of-arrival (AoA) estimate of the one or more RF signals, and a direction of the second arrow representing a mirror AoA estimate of the first AoA estimate; and displaying one or more notifications on the user interface instructing a user of the wireless device to move the wireless device until the direction of the first arrow is aligned with the direction of the second arrow.

Clause 2. The method of clause 1, further comprising: determining the first AoA estimate and the mirror AoA estimate in response to reception of each of the one or more RF signals; and updating the direction of the first arrow and the direction of the second arrow in response to each determination of the first AoA estimate and the mirror AoA estimate.

Clause 3. The method of clause 2, wherein the first AoA estimate and the mirror AoA estimate are determined without using sensor data from the wireless device.

Clause 4. The method of any of clauses 1 to 3, further comprising: displaying an indication of a distance between the wireless device and the transmitter device.

Clause 5. The method of any of clauses 1 to 4, wherein the first AoA estimate and the mirror AoA estimate are based on reception of the one or more RF signals by a linear antenna array of the wireless device.

Clause 6. The method of any of clauses 1 to 5, wherein the first AoA estimate and the mirror AoA estimate are azimuth-only angles.

Clause 7. A method of wireless positioning performed by a wireless device, comprising: receiving one or more radio frequency (RF) signals from a transmitter device; displaying one or more notifications on a user interface of the wireless device instructing a user of the wireless device to move the wireless device; determining an angle-of-arrival (AoA) of the one or more RF signals as corresponding to either a first AoA estimate of the one or more RF signals or a mirror AoA estimate of the first AoA estimate based on sensor data from one or more sensors of the wireless device, the sensor data indicating at least a direction of rotation of the wireless device caused by movement of the wireless device; and displaying an arrow on the user interface, a direction of the arrow representing the AoA of the one or more RF signals.

Clause 8. The method of clause 7, wherein the one or more sensors comprise a compass, one or more accelerometers, a gyroscope, a geomagnetic sensor, or any combination thereof.

Clause 9. The method of any of clauses 7 to 8, wherein: the one or more sensors comprise a compass, and the sensor data further indicates an amount of the rotation of the wireless device.

Clause 10. The method of any of clauses 7 to 9, further comprising: displaying a first arrow and a second arrow on the user interface until the AoA of the one or more RF signals is determined and the arrow is displayed, a direction of the first arrow representing the first AoA estimate and a direction of the second arrow representing the mirror AoA estimate.

Clause 11. The method of any of clauses 7 to 10, further comprising: displaying an indication of a distance between the wireless device and the transmitter device.

Clause 12. The method of any of clauses 7 to 11, wherein the first AoA estimate and the mirror AoA estimate are based on reception of the one or more RF signals by a linear antenna array of the wireless device.

Clause 13. The method of any of clauses 7 to 12, wherein the first AoA estimate and the mirror AoA estimate are azimuth-only angles.

Clause 14. A method of wireless positioning performed by a wireless device, comprising: displaying a three-dimensional shape on a user interface of the wireless device; displaying a pin on the three-dimensional shape, a position of the pin on the three-dimensional shape indicating an orientation of the wireless device relative to an azimuth plane or an elevation plane; displaying a target icon on the three-dimensional shape, a position of the target icon on the three-dimensional shape indicating a target position of the pin at which the orientation of the wireless device will be aligned with the azimuth plane or the elevation plane; and displaying a notification on the user interface instructing a user of the wireless device to move the wireless device until the pin is positioned on the target icon.

Clause 15. The method of clause 14, wherein: the target position of the pin is at a top of the three-dimensional shape, and the target position of the pin being at the top of the three-dimensional shape indicates that the orientation of the wireless device will be aligned with the azimuth plane.

Clause 16. The method of clause 14, wherein: the target position of the pin is at a middle of the three-dimensional shape, and the target position of the pin being at the middle of the three-dimensional shape indicates that the orientation of the wireless device will be aligned with the elevation plane.

Clause 17. The method of any of clauses 14 to 15, wherein: the position of the pin on the three-dimensional shape indicates the orientation of the wireless device relative to the azimuth plane, and the position of the target icon on the three-dimensional shape indicates the target position of the pin at which the orientation of the wireless device will be aligned with the azimuth plane.

Clause 18. The method of clause 17, further comprising: receiving one or more radio frequency (RF) signals from a transmitter device; and determining an angle-of-arrival (AoA) in the azimuth plane of the one or more RF signals.

Clause 19. The method of clause 18, wherein determining the AoA comprises: displaying a first arrow and a second arrow on the user interface, a direction of the first arrow representing a first AoA estimate in the azimuth plane of the one or more RF signals, and a direction of the second arrow representing a mirror AoA estimate in the azimuth plane of the first AoA estimate; and displaying one or more notifications on the user interface instructing the user to move the wireless device until the direction of the first arrow is aligned with the direction of the second arrow.

Clause 20. The method of any of clauses 18 to 19, wherein determining the AoA comprises: displaying one or more notifications on the user interface instructing the user to move the wireless device; determining an AoA of the one or more RF signals as corresponding to either a first AoA estimate of the one or more RF signals or a mirror AoA estimate of the first AoA estimate in the azimuth plane based on sensor data from one or more sensors of the wireless device, the sensor data indicating at least a direction of rotation of the wireless device caused by movement of the wireless device; and displaying an arrow on the user interface, a direction of the arrow representing the AoA of the one or more RF signals.

Clause 21. The method of any of clauses 17 to 20, further comprising: displaying a second pin on the three-dimensional shape, a position of the second pin on the three-dimensional shape indicating the orientation of the wireless device relative to the elevation plane; displaying a second target icon on the three-dimensional shape, a position of the second target icon on the three-dimensional shape indicating a second target position of the pin at which the orientation of the wireless device will be aligned with the elevation plane; and displaying a second notification on the user interface instructing the user of the wireless device to move the wireless device until the second pin is positioned on the second target icon.

Clause 22. The method of clause 21, further comprising: receiving one or more RF signals from a transmitter device; and determining an AoA in the elevation plane of the one or more RF signals.

Clause 23. The method of clause 22, wherein determining the AoA comprises: displaying a first arrow and a second arrow on the user interface, a direction of the first arrow representing a first AoA estimate in the elevation plane of the one or more RF signals, and a direction of the second arrow representing a minor AoA estimate in the elevation plane of the first AoA estimate; and displaying one or more notifications on the user interface instructing the user to move the wireless device until the direction of the first arrow is aligned with the direction of the second arrow.

Clause 24. The method of any of clauses 22 to 23, wherein determining the AoA comprises: displaying one or more notifications on the user interface instructing the user to move the wireless device; determining the AoA of the one or more RF signals as corresponding to either a first AoA estimate of the one or more RF signals or a mirror AoA estimate of the first AoA estimate in the elevation plane based on sensor data from one or more sensors of the wireless device, the sensor data indicating at least a direction of rotation of the wireless device caused by movement of the wireless device; and displaying an arrow on the user interface, a direction of the arrow representing the AoA of the one or more RF signals.

Clause 25. A method of wireless positioning performed by a wireless device, comprising: displaying one or more first notifications on a user interface of the wireless device instructing a user of the wireless device to hold the wireless device parallel to an azimuth plane; determining a first angle-of-arrival (AoA) in the azimuth plane of one or more first radio frequency (RF) signals received from a transmitter device; displaying one or more second notifications on the user interface instructing the user to hold the wireless device parallel to an elevation plane; and determining a second AoA in the elevation plane of one or more second RF signals received from the transmitter device.

Clause 26. The method of clause 25, wherein: the one or more first notifications include at least one first reminder to the user to hold the wireless device parallel to the azimuth plane, the one or more second notifications include at least one second reminder to the user to hold the wireless device parallel to the elevation plane.

Clause 27. The method of any of clauses 25 to 26, wherein the first AoA and the second AoA are determined without using sensor data from the wireless device.

Clause 28. The method of any of clauses 25 to 27, wherein the first AoA and the second AoA are determined based on reception of the one or more first RF signals and the one or more second RF signals, respectively, by a linear antenna array of the wireless device.

Clause 29. The method of any of clauses 25 to 28, wherein determining the first AoA comprises: displaying a first arrow and a second arrow on the user interface, a direction of the first arrow representing a first AoA estimate in the azimuth plane of the one or more RF signals, and a direction of the second arrow representing a mirror AoA estimate in the azimuth plane of the first AoA estimate in the azimuth plane; and displaying one or more notifications on the user interface instructing the user to move the wireless device until the direction of the first arrow is aligned with the direction of the second arrow.

Clause 30. The method of any of clauses 25 to 29, wherein determining the second AoA comprises: displaying a first arrow and a second arrow on the user interface, a direction of the first arrow representing a first AoA estimate in the elevation plane of the one or more RF signals, and a direction of the second arrow representing a mirror AoA estimate in the elevation plane of the first AoA estimate in the elevation plane; and displaying one or more notifications on the user interface instructing the user to move the wireless device until the direction of the first arrow is aligned with the direction of the second arrow.

Clause 31. A wireless device, comprising: one or more memories; one or more transceivers; and one or more processors communicatively coupled to the one or more memories and the one or more transceivers, the one or more processors, either alone or in combination, configured to: receive, via the one or more transceivers, one or more radio frequency (RF) signals from a transmitter device; display a first arrow and a second arrow on a user interface of the wireless device, a direction of the first arrow representing a first angle-of-arrival (AoA) estimate of the one or more RF signals, and a direction of the second arrow representing a mirror AoA estimate of the first AoA estimate; and display one or more notifications on the user interface instructing a user of the wireless device to move the wireless device until the direction of the first arrow is aligned with the direction of the second arrow.

Clause 32. The wireless device of clause 31, wherein the one or more processors, either alone or in combination, are further configured to: determine the first AoA estimate and the minor AoA estimate in response to reception of each of the one or more RF signals; and update the direction of the first arrow and the direction of the second arrow in response to each determination of the first AoA estimate and the mirror AoA estimate.

Clause 33. The wireless device of clause 32, wherein the first AoA estimate and the mirror AoA estimate are determined without using sensor data from the wireless device.

Clause 34. The wireless device of any of clauses 31 to 33, wherein the one or more processors, either alone or in combination, are further configured to: display an indication of a distance between the wireless device and the transmitter device.

Clause 35. The wireless device of any of clauses 31 to 34, wherein the first AoA estimate and the mirror AoA estimate are based on reception of the one or more RF signals by a linear antenna array of the wireless device.

Clause 36. The wireless device of any of clauses 31 to 35, wherein the first AoA estimate and the mirror AoA estimate are azimuth-only angles.

Clause 37. A wireless device, comprising: one or more memories; one or more transceivers; and one or more processors communicatively coupled to the one or more memories and the one or more transceivers, the one or more processors, either alone or in combination, configured to: receive, via the one or more transceivers, one or more radio frequency (RF) signals from a transmitter device; display one or more notifications on a user interface of the wireless device instructing a user of the wireless device to move the wireless device; determine an angle-of-arrival (AoA) of the one or more RF signals as corresponding to either a first AoA estimate of the one or more RF signals or a mirror AoA estimate of the first AoA estimate based on sensor data from one or more sensors of the wireless device, the sensor data indicating at least a direction of rotation of the wireless device caused by movement of the wireless device; and display an arrow on the user interface, a direction of the arrow representing the AoA of the one or more RF signals.

Clause 38. The wireless device of clause 37, wherein the one or more sensors comprise a compass, one or more accelerometers, a gyroscope, a geomagnetic sensor, or any combination thereof.

Clause 39. The wireless device of any of clauses 37 to 38, wherein: the one or more sensors comprise a compass, and the sensor data further indicates an amount of the rotation of the wireless device.

Clause 40. The wireless device of any of clauses 37 to 39, wherein the one or more processors, either alone or in combination, are further configured to: display a first arrow and a second arrow on the user interface until the AoA of the one or more RF signals is determined and the arrow is displayed, a direction of the first arrow representing the first AoA estimate and a direction of the second arrow representing the mirror AoA estimate.

Clause 41. The wireless device of any of clauses 37 to 40, wherein the one or more processors, either alone or in combination, are further configured to: display an indication of a distance between the wireless device and the transmitter device.

Clause 42. The wireless device of any of clauses 37 to 41, wherein the first AoA estimate and the mirror AoA estimate are based on reception of the one or more RF signals by a linear antenna array of the wireless device.

Clause 43. The wireless device of any of clauses 37 to 42, wherein the first AoA estimate and the minor AoA estimate are azimuth-only angles.

Clause 44. A wireless device, comprising: one or more memories; one or more transceivers; and one or more processors communicatively coupled to the one or more memories and the one or more transceivers, the one or more processors, either alone or in combination, configured to: display a three-dimensional shape on a user interface of the wireless device; display a pin on the three-dimensional shape, a position of the pin on the three-dimensional shape indicating an orientation of the wireless device relative to an azimuth plane or an elevation plane; display a target icon on the three-dimensional shape, a position of the target icon on the three-dimensional shape indicating a target position of the pin at which the orientation of the wireless device will be aligned with the azimuth plane or the elevation plane; and display a notification on the user interface instructing a user of the wireless device to move the wireless device until the pin is positioned on the target icon.

Clause 45. The wireless device of clause 44, wherein: the target position of the pin is at a top of the three-dimensional shape, and the target position of the pin being at the top of the three-dimensional shape indicates that the orientation of the wireless device will be aligned with the azimuth plane.

Clause 46. The wireless device of clause 44, wherein: the target position of the pin is at a middle of the three-dimensional shape, and the target position of the pin being at the middle of the three-dimensional shape indicates that the orientation of the wireless device will be aligned with the elevation plane.

Clause 47. The wireless device of any of clauses 44 to 45, wherein: the position of the pin on the three-dimensional shape indicates the orientation of the wireless device relative to the azimuth plane, and the position of the target icon on the three-dimensional shape indicates the target position of the pin at which the orientation of the wireless device will be aligned with the azimuth plane.

Clause 48. The wireless device of clause 47, wherein the one or more processors, either alone or in combination, are further configured to: receive, via the one or more transceivers, one or more radio frequency (RF) signals from a transmitter device; and determine an angle-of-arrival (AoA) in the azimuth plane of the one or more RF signals.

Clause 49. The wireless device of clause 48, wherein the one or more processors configured to determine the AoA comprises the one or more processors, either alone or in combination, configured to: display a first arrow and a second arrow on the user interface, a direction of the first arrow representing a first AoA estimate in the azimuth plane of the one or more RF signals, and a direction of the second arrow representing a mirror AoA estimate in the azimuth plane of the first AoA estimate; and display one or more notifications on the user interface instructing the user to move the wireless device until the direction of the first arrow is aligned with the direction of the second arrow.

Clause 50. The wireless device of any of clauses 48 to 49, wherein the one or more processors configured to determine the AoA comprises the one or more processors, either alone or in combination, configured to: display one or more notifications on the user interface instructing the user to move the wireless device; determine an AoA of the one or more RF signals as corresponding to either a first AoA estimate of the one or more RF signals or a mirror AoA estimate of the first AoA estimate in the azimuth plane based on sensor data from one or more sensors of the wireless device, the sensor data indicating at least a direction of rotation of the wireless device caused by movement of the wireless device; and display an arrow on the user interface, a direction of the arrow representing the AoA of the one or more RF signals.

Clause 51. The wireless device of any of clauses 47 to 50, wherein the one or more processors, either alone or in combination, are further configured to: display a second pin on the three-dimensional shape, a position of the second pin on the three-dimensional shape indicating the orientation of the wireless device relative to the elevation plane; display a second target icon on the three-dimensional shape, a position of the second target icon on the three-dimensional shape indicating a second target position of the pin at which the orientation of the wireless device will be aligned with the elevation plane; and display a second notification on the user interface instructing the user of the wireless device to move the wireless device until the second pin is positioned on the second target icon.

Clause 52. The wireless device of clause 51, wherein the one or more processors, either alone or in combination, are further configured to: receive, via the one or more transceivers, one or more RF signals from a transmitter device; and determine an AoA in the elevation plane of the one or more RF signals.

Clause 53. The wireless device of clause 52, wherein the one or more processors configured to determine the AoA comprises the one or more processors, either alone or in combination, configured to: display a first arrow and a second arrow on the user interface, a direction of the first arrow representing a first AoA estimate in the elevation plane of the one or more RF signals, and a direction of the second arrow representing a mirror AoA estimate in the elevation plane of the first AoA estimate; and display one or more notifications on the user interface instructing the user to move the wireless device until the direction of the first arrow is aligned with the direction of the second arrow.

Clause 54. The wireless device of any of clauses 52 to 53, wherein the one or more processors configured to determine the AoA comprises the one or more processors, either alone or in combination, configured to: display one or more notifications on the user interface instructing the user to move the wireless device; determine the AoA of the one or more RF signals as corresponding to either a first AoA estimate of the one or more RF signals or a minor AoA estimate of the first AoA estimate in the elevation plane based on sensor data from one or more sensors of the wireless device, the sensor data indicating at least a direction of rotation of the wireless device caused by movement of the wireless device; and display an arrow on the user interface, a direction of the arrow representing the AoA of the one or more RF signals.

Clause 55. A wireless device, comprising: one or more memories; one or more transceivers; and one or more processors communicatively coupled to the one or more memories and the one or more transceivers, the one or more processors, either alone or in combination, configured to: display one or more first notifications on a user interface of the wireless device instructing a user of the wireless device to hold the wireless device parallel to an azimuth plane; determine a first angle-of-arrival (AoA) in the azimuth plane of one or more first radio frequency (RF) signals received from a transmitter device; display one or more second notifications on the user interface instructing the user to hold the wireless device parallel to an elevation plane; and determine a second AoA in the elevation plane of one or more second RF signals received from the transmitter device.

Clause 56. The wireless device of clause 55, wherein: the one or more first notifications include at least one first reminder to the user to hold the wireless device parallel to the azimuth plane, the one or more second notifications include at least one second reminder to the user to hold the wireless device parallel to the elevation plane.

Clause 57. The wireless device of any of clauses 55 to 56, wherein the first AoA and the second AoA are determined without using sensor data from the wireless device.

Clause 58. The wireless device of any of clauses 55 to 57, wherein the first AoA and the second AoA are determined based on reception of the one or more first RF signals and the one or more second RF signals, respectively, by a linear antenna array of the wireless device.

Clause 59. The wireless device of any of clauses 55 to 58, wherein the one or more processors configured to determine the first AoA comprises the one or more processors, either alone or in combination, configured to: display a first arrow and a second arrow on the user interface, a direction of the first arrow representing a first AoA estimate in the azimuth plane of the one or more RF signals, and a direction of the second arrow representing a mirror AoA estimate in the azimuth plane of the first AoA estimate in the azimuth plane; and display one or more notifications on the user interface instructing the user to move the wireless device until the direction of the first arrow is aligned with the direction of the second arrow.

Clause 60. The wireless device of any of clauses 55 to 59, wherein the one or more processors configured to determine the second AoA comprises the one or more processors, either alone or in combination, configured to: display a first arrow and a second arrow on the user interface, a direction of the first arrow representing a first AoA estimate in the elevation plane of the one or more RF signals, and a direction of the second arrow representing a mirror AoA estimate in the elevation plane of the first AoA estimate in the elevation plane; and display one or more notifications on the user interface instructing the user to move the wireless device until the direction of the first arrow is aligned with the direction of the second arrow.

Clause 61. A wireless device, comprising: means for receiving one or more radio frequency (RF) signals from a transmitter device; means for displaying a first arrow and a second arrow on a user interface of the wireless device, a direction of the first arrow representing a first angle-of-arrival (AoA) estimate of the one or more RF signals, and a direction of the second arrow representing a minor AoA estimate of the first AoA estimate; and means for displaying one or more notifications on the user interface instructing a user of the wireless device to move the wireless device until the direction of the first arrow is aligned with the direction of the second arrow.

Clause 62. The wireless device of clause 61, further comprising: means for determining the first AoA estimate and the mirror AoA estimate in response to reception of each of the one or more RF signals; and means for updating the direction of the first arrow and the direction of the second arrow in response to each determination of the first AoA estimate and the mirror AoA estimate.

Clause 63. The wireless device of clause 62, wherein the first AoA estimate and the minor AoA estimate are determined without using sensor data from the wireless device.

Clause 64. The wireless device of any of clauses 61 to 63, further comprising: means for displaying an indication of a distance between the wireless device and the transmitter device.

Clause 65. The wireless device of any of clauses 61 to 64, wherein the first AoA estimate and the mirror AoA estimate are based on reception of the one or more RF signals by a linear antenna array of the wireless device.

Clause 66. The wireless device of any of clauses 61 to 65, wherein the first AoA estimate and the mirror AoA estimate are azimuth-only angles.

Clause 67. A wireless device, comprising: means for receiving one or more radio frequency (RF) signals from a transmitter device; means for displaying one or more notifications on a user interface of the wireless device instructing a user of the wireless device to move the wireless device; means for determining an angle-of-arrival (AoA) of the one or more RF signals as corresponding to either a first AoA estimate of the one or more RF signals or a mirror AoA estimate of the first AoA estimate based on sensor data from one or more sensors of the wireless device, the sensor data indicating at least a direction of rotation of the wireless device caused by movement of the wireless device; and means for displaying an arrow on the user interface, a direction of the arrow representing the AoA of the one or more RF signals.

Clause 68. The wireless device of clause 67, wherein the one or more sensors comprise a compass, one or more accelerometers, a gyroscope, a geomagnetic sensor, or any combination thereof.

Clause 69. The wireless device of any of clauses 67 to 68, wherein: the one or more sensors comprise a compass, and the sensor data further indicates an amount of the rotation of the wireless device.

Clause 70. The wireless device of any of clauses 67 to 69, further comprising: means for displaying a first arrow and a second arrow on the user interface until the AoA of the one or more RF signals is determined and the arrow is displayed, a direction of the first arrow representing the first AoA estimate and a direction of the second arrow representing the mirror AoA estimate.

Clause 71. The wireless device of any of clauses 67 to 70, further comprising: means for displaying an indication of a distance between the wireless device and the transmitter device.

Clause 72. The wireless device of any of clauses 67 to 71, wherein the first AoA estimate and the mirror AoA estimate are based on reception of the one or more RF signals by a linear antenna array of the wireless device.

Clause 73. The wireless device of any of clauses 67 to 72, wherein the first AoA estimate and the mirror AoA estimate are azimuth-only angles.

Clause 74. A wireless device, comprising: means for displaying a three-dimensional shape on a user interface of the wireless device; means for displaying a pin on the three-dimensional shape, a position of the pin on the three-dimensional shape indicating an orientation of the wireless device relative to an azimuth plane or an elevation plane; means for displaying a target icon on the three-dimensional shape, a position of the target icon on the three-dimensional shape indicating a target position of the pin at which the orientation of the wireless device will be aligned with the azimuth plane or the elevation plane; and means for displaying a notification on the user interface instructing a user of the wireless device to move the wireless device until the pin is positioned on the target icon.

Clause 75. The wireless device of clause 74, wherein: the target position of the pin is at a top of the three-dimensional shape, and the target position of the pin being at the top of the three-dimensional shape indicates that the orientation of the wireless device will be aligned with the azimuth plane.

Clause 76. The wireless device of clause 74, wherein: the target position of the pin is at a middle of the three-dimensional shape, and the target position of the pin being at the middle of the three-dimensional shape indicates that the orientation of the wireless device will be aligned with the elevation plane.

Clause 77. The wireless device of any of clauses 74 to 75, wherein: the position of the pin on the three-dimensional shape indicates the orientation of the wireless device relative to the azimuth plane, and the position of the target icon on the three-dimensional shape indicates the target position of the pin at which the orientation of the wireless device will be aligned with the azimuth plane.

Clause 78. The wireless device of clause 77, further comprising: means for receiving one or more radio frequency (RF) signals from a transmitter device; and means for determining an angle-of-arrival (AoA) in the azimuth plane of the one or more RF signals.

Clause 79. The wireless device of clause 78, wherein the means for determining the AoA comprises: means for displaying a first arrow and a second arrow on the user interface, a direction of the first arrow representing a first AoA estimate in the azimuth plane of the one or more RF signals, and a direction of the second arrow representing a mirror AoA estimate in the azimuth plane of the first AoA estimate; and means for displaying one or more notifications on the user interface instructing the user to move the wireless device until the direction of the first arrow is aligned with the direction of the second arrow.

Clause 80. The wireless device of any of clauses 78 to 79, wherein the means for determining the AoA comprises: means for displaying one or more notifications on the user interface instructing the user to move the wireless device; means for determining an AoA of the one or more RF signals as corresponding to either a first AoA estimate of the one or more RF signals or a mirror AoA estimate of the first AoA estimate in the azimuth plane based on sensor data from one or more sensors of the wireless device, the sensor data indicating at least a direction of rotation of the wireless device caused by movement of the wireless device; and means for displaying an arrow on the user interface, a direction of the arrow representing the AoA of the one or more RF signals.

Clause 81. The wireless device of any of clauses 77 to 80, further comprising: means for displaying a second pin on the three-dimensional shape, a position of the second pin on the three-dimensional shape indicating the orientation of the wireless device relative to the elevation plane; means for displaying a second target icon on the three-dimensional shape, a position of the second target icon on the three-dimensional shape indicating a second target position of the pin at which the orientation of the wireless device will be aligned with the elevation plane; and means for displaying a second notification on the user interface instructing the user of the wireless device to move the wireless device until the second pin is positioned on the second target icon.

Clause 82. The wireless device of clause 81, further comprising: means for receiving one or more RF signals from a transmitter device; and means for determining an AoA in the elevation plane of the one or more RF signals.

Clause 83. The wireless device of clause 82, wherein the means for determining the AoA comprises: means for displaying a first arrow and a second arrow on the user interface, a direction of the first arrow representing a first AoA estimate in the elevation plane of the one or more RF signals, and a direction of the second arrow representing a minor AoA estimate in the elevation plane of the first AoA estimate; and means for displaying one or more notifications on the user interface instructing the user to move the wireless device until the direction of the first arrow is aligned with the direction of the second arrow.

Clause 84. The wireless device of any of clauses 82 to 83, wherein the means for determining the AoA comprises: means for displaying one or more notifications on the user interface instructing the user to move the wireless device; means for determining the AoA of the one or more RF signals as corresponding to either a first AoA estimate of the one or more RF signals or a mirror AoA estimate of the first AoA estimate in the elevation plane based on sensor data from one or more sensors of the wireless device, the sensor data indicating at least a direction of rotation of the wireless device caused by movement of the wireless device; and means for displaying an arrow on the user interface, a direction of the arrow representing the AoA of the one or more RF signals.

Clause 85. A wireless device, comprising: means for displaying one or more first notifications on a user interface of the wireless device instructing a user of the wireless device to hold the wireless device parallel to an azimuth plane; means for determining a first angle-of-arrival (AoA) in the azimuth plane of one or more first radio frequency (RF) signals received from a transmitter device; means for displaying one or more second notifications on the user interface instructing the user to hold the wireless device parallel to an elevation plane; and means for determining a second AoA in the elevation plane of one or more second RF signals received from the transmitter device.

Clause 86. The wireless device of clause 85, wherein: the one or more first notifications include at least one first reminder to the user to hold the wireless device parallel to the azimuth plane, the one or more second notifications include at least one second reminder to the user to hold the wireless device parallel to the elevation plane.

Clause 87. The wireless device of any of clauses 85 to 86, wherein the first AoA and the second AoA are determined without using sensor data from the wireless device.

Clause 88. The wireless device of any of clauses 85 to 87, wherein the first AoA and the second AoA are determined based on reception of the one or more first RF signals and the one or more second RF signals, respectively, by a linear antenna array of the wireless device.

Clause 89. The wireless device of any of clauses 85 to 88, wherein the means for determining the first AoA comprises: means for displaying a first arrow and a second arrow on the user interface, a direction of the first arrow representing a first AoA estimate in the azimuth plane of the one or more RF signals, and a direction of the second arrow representing a mirror AoA estimate in the azimuth plane of the first AoA estimate in the azimuth plane; and means for displaying one or more notifications on the user interface instructing the user to move the wireless device until the direction of the first arrow is aligned with the direction of the second arrow.

Clause 90. The wireless device of any of clauses 85 to 89, wherein the means for determining the second AoA comprises: means for displaying a first arrow and a second arrow on the user interface, a direction of the first arrow representing a first AoA estimate in the elevation plane of the one or more RF signals, and a direction of the second arrow representing a mirror AoA estimate in the elevation plane of the first AoA estimate in the elevation plane; and means for displaying one or more notifications on the user interface instructing the user to move the wireless device until the direction of the first arrow is aligned with the direction of the second arrow.

Clause 91. A non-transitory computer-readable medium storing computer-executable instructions that, when executed by a wireless device, cause the wireless device to: receive one or more radio frequency (RF) signals from a transmitter device; display a first arrow and a second arrow on a user interface of the wireless device, a direction of the first arrow representing a first angle-of-arrival (AoA) estimate of the one or more RF signals, and a direction of the second arrow representing a mirror AoA estimate of the first AoA estimate; and display one or more notifications on the user interface instructing a user of the wireless device to move the wireless device until the direction of the first arrow is aligned with the direction of the second arrow.

Clause 92. The non-transitory computer-readable medium of clause 91, further comprising computer-executable instructions that, when executed by the wireless device, cause the wireless device to: determine the first AoA estimate and the minor AoA estimate in response to reception of each of the one or more RF signals; and update the direction of the first arrow and the direction of the second arrow in response to each determination of the first AoA estimate and the mirror AoA estimate.

Clause 93. The non-transitory computer-readable medium of clause 92, wherein the first AoA estimate and the minor AoA estimate are determined without using sensor data from the wireless device.

Clause 94. The non-transitory computer-readable medium of any of clauses 91 to 93, further comprising computer-executable instructions that, when executed by the wireless device, cause the wireless device to: display an indication of a distance between the wireless device and the transmitter device.

Clause 95. The non-transitory computer-readable medium of any of clauses 91 to 94, wherein the first AoA estimate and the mirror AoA estimate are based on reception of the one or more RF signals by a linear antenna array of the wireless device.

Clause 96. The non-transitory computer-readable medium of any of clauses 91 to 95, wherein the first AoA estimate and the minor AoA estimate are azimuth-only angles.

Clause 97. A non-transitory computer-readable medium storing computer-executable instructions that, when executed by a wireless device, cause the wireless device to: receive one or more radio frequency (RF) signals from a transmitter device; display one or more notifications on a user interface of the wireless device instructing a user of the wireless device to move the wireless device; determine an angle-of-arrival (AoA) of the one or more RF signals as corresponding to either a first AoA estimate of the one or more RF signals or a mirror AoA estimate of the first AoA estimate based on sensor data from one or more sensors of the wireless device, the sensor data indicating at least a direction of rotation of the wireless device caused by movement of the wireless device; and display an arrow on the user interface, a direction of the arrow representing the AoA of the one or more RF signals.

Clause 98. The non-transitory computer-readable medium of clause 97, wherein the one or more sensors comprise a compass, one or more accelerometers, a gyroscope, a geomagnetic sensor, or any combination thereof.

Clause 99. The non-transitory computer-readable medium of any of clauses 97 to 98, wherein: the one or more sensors comprise a compass, and the sensor data further indicates an amount of the rotation of the wireless device.

Clause 100. The non-transitory computer-readable medium of any of clauses 97 to 99, further comprising computer-executable instructions that, when executed by the wireless device, cause the wireless device to: display a first arrow and a second arrow on the user interface until the AoA of the one or more RF signals is determined and the arrow is displayed, a direction of the first arrow representing the first AoA estimate and a direction of the second arrow representing the mirror AoA estimate.

Clause 101. The non-transitory computer-readable medium of any of clauses 97 to 100, further comprising computer-executable instructions that, when executed by the wireless device, cause the wireless device to: display an indication of a distance between the wireless device and the transmitter device.

Clause 102. The non-transitory computer-readable medium of any of clauses 97 to 101, wherein the first AoA estimate and the mirror AoA estimate are based on reception of the one or more RF signals by a linear antenna array of the wireless device.

Clause 103. The non-transitory computer-readable medium of any of clauses 97 to 102, wherein the first AoA estimate and the mirror AoA estimate are azimuth-only angles.

Clause 104. A non-transitory computer-readable medium storing computer-executable instructions that, when executed by a wireless device, cause the wireless device to: display a three-dimensional shape on a user interface of the wireless device; display a pin on the three-dimensional shape, a position of the pin on the three-dimensional shape indicating an orientation of the wireless device relative to an azimuth plane or an elevation plane; display a target icon on the three-dimensional shape, a position of the target icon on the three-dimensional shape indicating a target position of the pin at which the orientation of the wireless device will be aligned with the azimuth plane or the elevation plane; and display a notification on the user interface instructing a user of the wireless device to move the wireless device until the pin is positioned on the target icon.

Clause 105. The non-transitory computer-readable medium of clause 104, wherein: the target position of the pin is at a top of the three-dimensional shape, and the target position of the pin being at the top of the three-dimensional shape indicates that the orientation of the wireless device will be aligned with the azimuth plane.

Clause 106. The non-transitory computer-readable medium of clause 104, wherein: the target position of the pin is at a middle of the three-dimensional shape, and the target position of the pin being at the middle of the three-dimensional shape indicates that the orientation of the wireless device will be aligned with the elevation plane.

Clause 107. The non-transitory computer-readable medium of any of clauses 104 to 105, wherein: the position of the pin on the three-dimensional shape indicates the orientation of the wireless device relative to the azimuth plane, and the position of the target icon on the three-dimensional shape indicates the target position of the pin at which the orientation of the wireless device will be aligned with the azimuth plane.

Clause 108. The non-transitory computer-readable medium of clause 107, further comprising computer-executable instructions that, when executed by the wireless device, cause the wireless device to: receive one or more radio frequency (RF) signals from a transmitter device; and determine an angle-of-arrival (AoA) in the azimuth plane of the one or more RF signals.

Clause 109. The non-transitory computer-readable medium of clause 108, wherein the computer-executable instructions that, when executed by the wireless device, cause the wireless device to determine the AoA comprise computer-executable instructions that, when executed by the wireless device, cause the wireless device to: display a first arrow and a second arrow on the user interface, a direction of the first arrow representing a first AoA estimate in the azimuth plane of the one or more RF signals, and a direction of the second arrow representing a minor AoA estimate in the azimuth plane of the first AoA estimate; and display one or more notifications on the user interface instructing the user to move the wireless device until the direction of the first arrow is aligned with the direction of the second arrow.

Clause 110. The non-transitory computer-readable medium of any of clauses 108 to 109, wherein the computer-executable instructions that, when executed by the wireless device, cause the wireless device to determine the AoA comprise computer-executable instructions that, when executed by the wireless device, cause the wireless device to: display one or more notifications on the user interface instructing the user to move the wireless device; determine an AoA of the one or more RF signals as corresponding to either a first AoA estimate of the one or more RF signals or a minor AoA estimate of the first AoA estimate in the azimuth plane based on sensor data from one or more sensors of the wireless device, the sensor data indicating at least a direction of rotation of the wireless device caused by movement of the wireless device; and display an arrow on the user interface, a direction of the arrow representing the AoA of the one or more RF signals.

Clause 111. The non-transitory computer-readable medium of any of clauses 107 to 110, further comprising computer-executable instructions that, when executed by the wireless device, cause the wireless device to: display a second pin on the three-dimensional shape, a position of the second pin on the three-dimensional shape indicating the orientation of the wireless device relative to the elevation plane; display a second target icon on the three-dimensional shape, a position of the second target icon on the three-dimensional shape indicating a second target position of the pin at which the orientation of the wireless device will be aligned with the elevation plane; and display a second notification on the user interface instructing the user of the wireless device to move the wireless device until the second pin is positioned on the second target icon.

Clause 112. The non-transitory computer-readable medium of clause 111, further comprising computer-executable instructions that, when executed by the wireless device, cause the wireless device to: receive one or more RF signals from a transmitter device; and determine an AoA in the elevation plane of the one or more RF signals.

Clause 113. The non-transitory computer-readable medium of clause 112, wherein the computer-executable instructions that, when executed by the wireless device, cause the wireless device to determine the AoA comprise computer-executable instructions that, when executed by the wireless device, cause the wireless device to: display a first arrow and a second arrow on the user interface, a direction of the first arrow representing a first AoA estimate in the elevation plane of the one or more RF signals, and a direction of the second arrow representing a mirror AoA estimate in the elevation plane of the first AoA estimate; and display one or more notifications on the user interface instructing the user to move the wireless device until the direction of the first arrow is aligned with the direction of the second arrow.

Clause 114. The non-transitory computer-readable medium of any of clauses 112 to 113, wherein the computer-executable instructions that, when executed by the wireless device, cause the wireless device to determine the AoA comprise computer-executable instructions that, when executed by the wireless device, cause the wireless device to: display one or more notifications on the user interface instructing the user to move the wireless device; determine the AoA of the one or more RF signals as corresponding to either a first AoA estimate of the one or more RF signals or a mirror AoA estimate of the first AoA estimate in the elevation plane based on sensor data from one or more sensors of the wireless device, the sensor data indicating at least a direction of rotation of the wireless device caused by movement of the wireless device; and display an arrow on the user interface, a direction of the arrow representing the AoA of the one or more RF signals.

Clause 115. A non-transitory computer-readable medium storing computer-executable instructions that, when executed by a wireless device, cause the wireless device to: display one or more first notifications on a user interface of the wireless device instructing a user of the wireless device to hold the wireless device parallel to an azimuth plane; determine a first angle-of-arrival (AoA) in the azimuth plane of one or more first radio frequency (RF) signals received from a transmitter device; display one or more second notifications on the user interface instructing the user to hold the wireless device parallel to an elevation plane; and determine a second AoA in the elevation plane of one or more second RF signals received from the transmitter device.

Clause 116. The non-transitory computer-readable medium of clause 115, wherein: the one or more first notifications include at least one first reminder to the user to hold the wireless device parallel to the azimuth plane, the one or more second notifications include at least one second reminder to the user to hold the wireless device parallel to the elevation plane.

Clause 117. The non-transitory computer-readable medium of any of clauses 115 to 116, wherein the first AoA and the second AoA are determined without using sensor data from the wireless device.

Clause 118. The non-transitory computer-readable medium of any of clauses 115 to 117, wherein the first AoA and the second AoA are determined based on reception of the one or more first RF signals and the one or more second RF signals, respectively, by a linear antenna array of the wireless device.

Clause 119. The non-transitory computer-readable medium of any of clauses 115 to 118, wherein the computer-executable instructions that, when executed by the wireless device, cause the wireless device to determine the first AoA comprise computer-executable instructions that, when executed by the wireless device, cause the wireless device to: display a first arrow and a second arrow on the user interface, a direction of the first arrow representing a first AoA estimate in the azimuth plane of the one or more RF signals, and a direction of the second arrow representing a mirror AoA estimate in the azimuth plane of the first AoA estimate in the azimuth plane; and display one or more notifications on the user interface instructing the user to move the wireless device until the direction of the first arrow is aligned with the direction of the second arrow.

Clause 120. The non-transitory computer-readable medium of any of clauses 115 to 119, wherein the computer-executable instructions that, when executed by the wireless device, cause the wireless device to determine the second AoA comprise computer-executable instructions that, when executed by the wireless device, cause the wireless device to: display a first arrow and a second arrow on the user interface, a direction of the first arrow representing a first AoA estimate in the elevation plane of the one or more RF signals, and a direction of the second arrow representing a minor AoA estimate in the elevation plane of the first AoA estimate in the elevation plane; and display one or more notifications on the user interface instructing the user to move the wireless device until the direction of the first arrow is aligned with the direction of the second arrow.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of wireless positioning performed by a wireless device, comprising:
receiving one or more radio frequency (RF) signals from a transmitter device;
displaying a first arrow and a second arrow on a user interface of the wireless device, a direction of the first arrow representing a first angle-of-arrival (AoA) estimate of the one or more RF signals, and a direction of the second arrow representing a mirror AoA estimate of the first AoA estimate; and
displaying one or more notifications on the user interface instructing a user of the wireless device to move the wireless device until the direction of the first arrow is aligned with the direction of the second arrow.

2. The method of claim 1, further comprising:
determining the first AoA estimate and the mirror AoA estimate in response to reception of each of the one or more RF signals; and
updating the direction of the first arrow and the direction of the second arrow in response to each determination of the first AoA estimate and the mirror AoA estimate.

3. The method of claim 2, wherein the first AoA estimate and the mirror AoA estimate are determined without using sensor data from the wireless device.

4. The method of claim 1, further comprising:
displaying an indication of a distance between the wireless device and the transmitter device.

5. The method of claim 1, wherein the first AoA estimate and the mirror AoA estimate are based on reception of the one or more RF signals by a linear antenna array of the wireless device.

6. The method of claim 1, wherein the first AoA estimate and the mirror AoA estimate are azimuth-only angles.

7. A method of wireless positioning performed by a wireless device, comprising:
receiving one or more radio frequency (RF) signals from a transmitter device;
displaying one or more notifications on a user interface of the wireless device instructing a user of the wireless device to move the wireless device;
determining an angle-of-arrival (AoA) of the one or more RF signals as corresponding to either a first AoA estimate of the one or more RF signals or a mirror AoA estimate of the first AoA estimate based on sensor data from one or more sensors of the wireless device, the sensor data indicating at least a direction of rotation of the wireless device caused by movement of the wireless device; and
displaying an arrow on the user interface, a direction of the arrow representing the AoA of the one or more RF signals.

8. The method of claim 7, wherein the one or more sensors comprise a compass, one or more accelerometers, a gyroscope, a geomagnetic sensor, or any combination thereof.

9. The method of claim 7, wherein:
the one or more sensors comprise a compass, and
the sensor data further indicates an amount of the rotation of the wireless device.

10. The method of claim 7, further comprising:
displaying a first arrow and a second arrow on the user interface until the AoA of the one or more RF signals is determined and the arrow is displayed, a direction of the first arrow representing the first AoA estimate and a direction of the second arrow representing the mirror AoA estimate.

11. The method of claim 7, further comprising:
displaying an indication of a distance between the wireless device and the transmitter device.

12. The method of claim 7, wherein the first AoA estimate and the mirror AoA estimate are based on reception of the one or more RF signals by a linear antenna array of the wireless device.

13. The method of claim 7, wherein the first AoA estimate and the mirror AoA estimate are azimuth-only angles.

14. A method of wireless positioning performed by a wireless device, comprising:
displaying a three-dimensional shape on a user interface of the wireless device;
displaying a pin on the three-dimensional shape, a position of the pin on the three-dimensional shape indicating an orientation of the wireless device relative to an azimuth plane or an elevation plane;
displaying a target icon on the three-dimensional shape, a position of the target icon on the three-dimensional shape indicating a target position of the pin at which the orientation of the wireless device will be aligned with the azimuth plane or the elevation plane; and
displaying a notification on the user interface instructing a user of the wireless device to move the wireless device until the pin is positioned on the target icon.

15. The method of claim 14, wherein:
the target position of the pin is at a top of the three-dimensional shape, and
the target position of the pin being at the top of the three-dimensional shape indicates that the orientation of the wireless device will be aligned with the azimuth plane.

16. The method of claim 14, wherein:
the target position of the pin is at a middle of the three-dimensional shape, and
the target position of the pin being at the middle of the three-dimensional shape indicates that the orientation of the wireless device will be aligned with the elevation plane.

17. The method of claim 14, wherein:
the position of the pin on the three-dimensional shape indicates the orientation of the wireless device relative to the azimuth plane, and
the position of the target icon on the three-dimensional shape indicates the target position of the pin at which the orientation of the wireless device will be aligned with the azimuth plane.

18. The method of claim 17, further comprising:
receiving one or more radio frequency (RF) signals from a transmitter device; and
determining an angle-of-arrival (AoA) in the azimuth plane of the one or more RF signals.

19. The method of claim 18, wherein determining the AoA comprises:
displaying a first arrow and a second arrow on the user interface, a direction of the first arrow representing a first AoA estimate in the azimuth plane of the one or more RF signals, and a direction of the second arrow representing a mirror AoA estimate in the azimuth plane of the first AoA estimate; and
displaying one or more notifications on the user interface instructing the user to move the wireless device until the direction of the first arrow is aligned with the direction of the second arrow.

20. The method of claim 18, wherein determining the AoA comprises:
displaying one or more notifications on the user interface instructing the user to move the wireless device;
determining an AoA of the one or more RF signals as corresponding to either a first AoA estimate of the one or more RF signals or a mirror AoA estimate of the first AoA estimate in the azimuth plane based on sensor data from one or more sensors of the wireless device, the sensor data indicating at least a direction of rotation of the wireless device caused by movement of the wireless device; and
displaying an arrow on the user interface, a direction of the arrow representing the AoA of the one or more RF signals.

21. The method of claim 17, further comprising:
displaying a second pin on the three-dimensional shape, a position of the second pin on the three-dimensional shape indicating the orientation of the wireless device relative to the elevation plane;
displaying a second target icon on the three-dimensional shape, a position of the second target icon on the three-dimensional shape indicating a second target position of the pin at which the orientation of the wireless device will be aligned with the elevation plane; and
displaying a second notification on the user interface instructing the user of the wireless device to move the wireless device until the second pin is positioned on the second target icon.

22. The method of claim 21, further comprising:
receiving one or more RF signals from a transmitter device; and
determining an AoA in the elevation plane of the one or more RF signals.

23. The method of claim 22, wherein determining the AoA comprises:
displaying a first arrow and a second arrow on the user interface, a direction of the first arrow representing a first AoA estimate in the elevation plane of the one or more RF signals, and a direction of the second arrow representing a mirror AoA estimate in the elevation plane of the first AoA estimate; and
displaying one or more notifications on the user interface instructing the user to move the wireless device until the direction of the first arrow is aligned with the direction of the second arrow.

24. The method of claim 22, wherein determining the AoA comprises:
displaying one or more notifications on the user interface instructing the user to move the wireless device;
determining the AoA of the one or more RF signals as corresponding to either a first AoA estimate of the one or more RF signals or a mirror AoA estimate of the first AoA estimate in the elevation plane based on sensor data from one or more sensors of the wireless device, the sensor data indicating at least a direction of rotation of the wireless device caused by movement of the wireless device; and
displaying an arrow on the user interface, a direction of the arrow representing the AoA of the one or more RF signals.

25. A method of wireless positioning performed by a wireless device, comprising:
displaying one or more first notifications on a user interface of the wireless device instructing a user of the wireless device to hold the wireless device parallel to an azimuth plane;
determining a first angle-of-arrival (AoA) in the azimuth plane of one or more first radio frequency (RF) signals received from a transmitter device;
displaying one or more second notifications on the user interface instructing the user to hold the wireless device parallel to an elevation plane; and
determining a second AoA in the elevation plane of one or more second RF signals received from the transmitter device.

26. The method of claim 25, wherein:
the one or more first notifications include at least one first reminder to the user to hold the wireless device parallel to the azimuth plane,
the one or more second notifications include at least one second reminder to the user to hold the wireless device parallel to the elevation plane.

27. The method of claim 25, wherein the first AoA and the second AoA are determined without using sensor data from the wireless device.

28. The method of claim 25, wherein the first AoA and the second AoA are determined based on reception of the one or more first RF signals and the one or more second RF signals, respectively, by a linear antenna array of the wireless device.

29. The method of claim 25, wherein determining the first AoA comprises:
displaying a first arrow and a second arrow on the user interface, a direction of the first arrow representing a first AoA estimate in the azimuth plane of the one or more RF signals, and a direction of the second arrow representing a mirror AoA estimate in the azimuth plane of the first AoA estimate in the azimuth plane; and
displaying one or more notifications on the user interface instructing the user to move the wireless device until the direction of the first arrow is aligned with the direction of the second arrow.

30. The method of claim 25, wherein determining the second AoA comprises:
displaying a first arrow and a second arrow on the user interface, a direction of the first arrow representing a first AoA estimate in the elevation plane of the one or more RF signals, and a direction of the second arrow representing a mirror AoA estimate in the elevation plane of the first AoA estimate in the elevation plane; and
displaying one or more notifications on the user interface instructing the user to move the wireless device until the direction of the first arrow is aligned with the direction of the second arrow.
